(19) United States
(12) Patent Application Publication
(10) Pub. No.: US 2012/0209600 A1
(43) Pub. Date: Aug. 16, 2012

(54) INTEGRATED VOICE/AUDIO ENCODING/DECODING DEVICE AND METHOD WHEREBY THE OVERLAP REGION OF A WINDOW IS ADJUSTED BASED ON THE TRANSITION INTERVAL

(75) Inventors: Min Je Kim, Daejeon (KR); Seung Kwon Beack, Daejeon (KR); Tae Jin Lee, Daejeon (KR); Kyeong Ok Kang, Daejeon (KR); Jeongil Seo, Daejeon (KR); Jin Woong Kim, Daejeon (KR); Jin Woo Hong, Daejeon (KR); Ho Chong Park, Seoul (KR); Young Cheol Park, Seoul (KR)

(73) Assignees: Kwangwoon University Industry-Academic Collaboration Foundation, Seoul (KR); Electronics and Telecommunications Research Institute, Daejeon (KR)

(21) Appl. No.: 13/502,025

(22) PCT Filed: Oct. 11, 2010
(86) PCT No.: PCT/KR2010/006931

§ 371 Date: Apr. 13, 2012

(30) Foreign Application Priority Data
Oct. 14, 2009 (KR) 10-2009-0097592
Nov. 16, 2009 (KR) 10-2009-0110426
Sep. 10, 2010 (KR) 10-2010-0089038

(51) Int. Cl. G10L 19/04; G10L 11/00

(52) U.S. Cl. 704/219; 704/200; 704/E19.048; 704/E11.001

(57) ABSTRACT

A Unified Speech and Audio Codec (USAC) for adjusting an overlap area of a window based on a transition is provided. To increase an encoding efficiency, encoding may be performed by overlapping relatively long windows. Additionally, when a transition is generated between frames, an overlap area of a window may be reduced based on the transition, thereby preventing a noise from occurring due to the transition.

### TECHNICAL FIELD

The present invention relates to a Modified Discrete Cosine Transform (MDCT)-based Unified Speech and Audio Codec (USAC), and more particularly, to a MDCT-based USAC and unified speech and audio encoding/decoding method that may adjust a length of an overlap area of a window based on a transition in a window sequence.

### BACKGROUND ART

In a Modified Discrete Cosine Transform (MDCT)-based Unified Speech and Audio Codec (USAC), different window sequences may be applied to an input signal based on coding modes of frames forming the input signal. Here, to cancel an aliasing in a time domain that occurs by an MDCT, a Time-Domain Aliasing Cancellation (TDAC) needs to be satisfied. To satisfy the TDAC, windows needs to be overlapped and applied between a current frame and a previous frame or a next frame that is disposed adjacent to the current frame.

Generally, an encoding apparatus may divide an intra frame into sub-frames with appropriate lengths in order to maximize an encoding gain. Here, an encoding gain of audio or speech may be increased when a super frame in a time domain forming an input signal into relatively long sub-frames. Accordingly, window sequences may be applied for each sub-frame. Here, a transition may be generated in a location adjacent to a boundary of an intra-frame. Additionally, when encoding is performed by applying a window overlapping between frames, a problem may be caused by the transition. Specifically, the transition refers to a section where properties of speech signals are rapidly changed, and may be generated for a short period of time. A signal of a transition generated for a relatively short period of time due to an overlap of windows between long frames may not be efficiently represented, thereby causing a noise such as a pre-echo.

To solve such a problem, a scheme of recognizing a generation of a transition, dividing and converting a time domain signal into relatively short frames, and reducing a period where a pre-echo occurs in a restored signal may be used. In particular, there is a need for a method of applying the scheme to an MDCT-based USAC.

### DISCLOSURE OF INVENTION

### Technical Goals

The present invention provides a system and method that may reduce a pre-echo occurring in a transition, by adjusting an overlap area of a window in a section where the transition is generated, when windows are overlapped between long frames in order to improve an encoding efficiency.

### Technical Solutions

According to an aspect of the present invention, there is provided a Unified Speech and Audio Codec (USAC), including: a transition detector to detect a first transition from an input signal; a first encoder to encode the input signal and to detect a second transition from a result of the encoding; a transition determination unit to compare the first transition and the second transition and to determine a final transition; a second encoder to core-encode the input signal by adjusting a length of an overlap area of a window based on the determined transition; and a bitstream formatter to generate a bitstream including the core-encoded input signal and the final transition.

The first encoder may perform either a Spectral Bandwidth Extension (SBE) encoding scheme or a Parametric Stereo (PS) encoding scheme.

The transition detector may detect a transition in a location adjacent to a boundary of a super frame including at least one sub-frame among a plurality of sub-frames in the input signal.

The second encoder may core-encode the input signal by applying a window having an overlap area of which a length is reduced by a transition based on a folding point.

The second encoder may core-encode the input signal by applying, to a current sub-frame to be encoded, a window that is changed based on a Linear Prediction Domain (LPD) mode of a previous sub-frame and an LPD mode of a next sub-frame.

According to another aspect of the present invention, there is provided a USAC, including: a first encoder to encode an input signal and to detect a transition from a result of the encoding; a second encoder to core-encode the input signal by adjusting a length of an overlap area of a window based on the detected transition; and a bitstream formatter to generate a bitstream including the core-encoded input signal.

The first encoder may perform either an SBE encoding scheme or a PPS encoding scheme.

The second encoder may core-encode the input signal by applying a window having an overlap area of which a length is reduced by a transition based on a folding point.

The second encoder may core-encode the input signal by applying, to a current sub-frame to be encoded, a window that is changed based on an LPD mode of a previous sub-frame and an LPD mode of a next sub-frame.

According to another aspect of the present invention, there is provided a USAC, including: a bitstream parser to parse a bitstream and to extract a transition; and a decoder to core-decode an input signal by adjusting a length of an overlap area of a window based on the transition.

The decoder may core-decode the input signal by applying a window having an overlap area of which a length is reduced by a transition based on a folding point.

The decoder may core-decode the input signal by applying, to a current sub-frame to be decoded, a window that is changed based on an LPD mode of a previous sub-frame and an LPD mode of a next sub-frame.

The transition may be either a transition extracted from an input signal, or a transition extracted from a result of encoding an input signal.

According to another aspect of the present invention, there is provided a USAC, including: a bitstream parser to parse an input signal from a bitstream; a first decoder to decode the input signal and to detect a transition from a result of the decoding; and a second decoder to core-decode the input signal by adjusting a length of an overlap area of a window based on the detected transition.

The first decoder performs either an SBE decoding scheme or a PS decoding scheme, and the second decoder may core-decode the input signal by applying a window having an overlap area of which a length is reduced by a transition based on a folding point.

The second decoder may core-decode the input signal by applying, to a current sub-frame to be decoded, a window that is changed based on an LPD mode of a previous sub-frame and an LPD mode of a next sub-frame.

According to another aspect of the present invention, there is provided a method performed by a USAC, the method including: detecting a first transition from an input signal; encoding the input signal and detecting a second transition from a result of the encoding; comparing the first transition and the second transition and determining a final transition; core-encoding the input signal by adjusting a length of an overlap area of a window based on the determined transition; and generating a bitstream including the core-encoded input signal and the final transition.

According to another aspect of the present invention, there is provided a method performed by a USAC, the method including: encoding an input signal and detecting a transition from a result of the encoding; core-encoding the input signal by adjusting a length of an overlap area of a window based on the detected transition; and generating a bitstream including the core-encoded input signal.

According to another aspect of the present invention, there is provided a method performed by a USAC, the method including: parsing a bitstream and extracting a transition; and core-decoding an input signal by adjusting a length of an overlap area of a window based on the transition.

According to another aspect of the present invention, there is provided a method performed by a USAC, the method including: parsing an input signal from a bitstream; decoding the input signal and detecting a transition from a result of the decoding; and core-decoding the input signal by adjusting a length of an overlap area of a window based on the detected transition.

### Advantageous Effects

According to an embodiment of the present invention, there may be provided a system and method that may reduce a pre-echo occurring in a transition, by adjusting an overlap area of a window in a section where the transition is generated, when windows are overlapped between long frames in order to improve an encoding efficiency.

### BRIEF DESCRIPTION OF DRAWINGS

FIG. 1 is a block diagram illustrating a configuration of a Unified Speech and Audio Codec (USAC) according to an embodiment of the present invention;

FIG. 2 is a diagram illustrating a Modified Discrete Cosine Transform (MDCT)-based Time Domain Aliasing Cancellation (TDAC);

FIG. 3 is a diagram illustrating a window sequence defined in a Reference Model (RM) in a conventional art;

FIG. 4 is a diagram illustrating a window sequence ‘CASE 1: ONLY_LONG_SEQUENCE to LPD_START_SEQUENCE’;

FIG. 5 is a diagram illustrating a window sequence ‘CASE 2: LONG_STOP_SEQUENCE to LPD_START_SEQUENCE’;

FIG. 6 is a diagram illustrating a window sequence ‘CASE 3: LPD_START_SEQUENCE to LPD_SEQUENCE’ when mode switching occurs from a Frequency Domain (FD) to a Linear Prediction Domain (LPD) mode;

FIG. 7 is a diagram illustrating a window sequence ‘CASE 4: LPD_SEQUENCE to LPD_SEQUENCE’ when mode switching occurs from an LPD mode to an LPD mode, and a window sequence ‘CASE 4: LPD_SEQUENCE to STOP_{—}1152_SEQUENCE or STOP_START_{—}1152_SEQUENCE’ when mode switching occurs from an LPD mode to a FD mode;

FIG. 8 is a diagram illustrating window shapes of ‘LPD_SEQUENCE’ for each type;

FIG. 9 is a diagram illustrating ‘LPD_SEQUENCE’ (a) when an LPD mode is {1, 1, 1, 1}, (b) when an LPD mode is {2, 2, 2, 2}, and (c) when an LPD mode is {3, 3, 3, 3};

FIG. 10 is a diagram illustrating ‘LPD_SEQUENCE’ when an LPD mode is {0, 1, 1, 1};

FIG. 11 is a diagram illustrating ‘LPD_SEQUENCE’ when an LPD mode is {1, 0, 2, 2};

FIG. 12 is a diagram illustrating ‘LPD_SEQUENCE’ where an LPD mode is {3, 3, 3, 3}, when an LPD mode of an end sub-frame of a previous frame is {0};

FIG. 13 is a diagram illustrating a window sequence processing method with respect to CASE 3 in a conventional art;

FIG. 14 is a diagram illustrating a first example of a window sequence processing method with respect to CASE 3 according to an embodiment of the present invention;

FIG. 15 is a diagram illustrating a second example of a window sequence processing method with respect to CASE 3 according to an embodiment of the present invention;

FIG. 16 is a diagram illustrating a third example of a window sequence processing method with respect to CASE 3 according to an embodiment of the present invention;

FIG. 17 is a diagram illustrating a window when an LPD mode of ‘LPD_SEQUENCE’ with respect to a current sub-frame is 3, and when an LPD mode of ‘LPD_SEQUENCE’ with respect to a next sub-frame is 3 according to an embodiment of the present invention;

FIG. 18 is a diagram illustrating a window when an LPD mode of ‘LPD_SEQUENCE’ with respect to a current sub-frame is 2, and when an LPD mode of ‘LPD_SEQUENCE’ with respect to a next sub-frame is 2 according to an embodiment of the present invention;

FIG. 19 is a diagram illustrating a window when an LPD mode of ‘LPD_SEQUENCE’ with respect to a current sub-frame is 1, and when an LPD mode of ‘LPD_SEQUENCE’ with respect to a next sub-frame is 1 according to an embodiment of the present invention;

FIG. 20 is a diagram illustrating a window sequence processing method with respect to CASE 4 in a conventional art;

FIG. 21 is a diagram illustrating a first example of a window sequence processing method with respect to CASE 4 according to an embodiment of the present invention;

FIG. 22 is a diagram illustrating a second example of a window sequence processing method with respect to CASE 4 according to an embodiment of the present invention;

FIG. 23 is a diagram illustrating a third example of a window sequence processing method with respect to CASE 4 according to an embodiment of the present invention;

FIG. 24 is a diagram illustrating ‘STOP_{—}1024_SEQUENCE’ where the window sequence of FIG. 22 is applied according to an embodiment of the present invention;

FIG. 25 is a diagram illustrating results where the window sequences of FIG. 16 and FIG. 24 are applied according to an embodiment of the present invention;

FIG. 26 is a diagram illustrating a window when an Algebraic Code Excited Linear Prediction (ACELP) is changed to a FD according to an embodiment of the present invention;

FIG. 27 is a diagram illustrating a window sequence and a Linear Prediction Coefficient (LPC) extraction location based on an LPD mode of a current frame and an LPD mode of a next frame according to an embodiment of the present invention;

FIG. 28 is a diagram illustrating an LPC extraction location in a conventional art and an LPC extraction location according to an embodiment of the present invention;

FIG. 29 is a diagram illustrating a window sequence when lpd_mode={1, 0, 1, 1} according to an embodiment of the present invention;

FIG. 30 is a diagram illustrating a window sequence when lpd_mode={1, 0, 2, 2} according to an embodiment of the present invention;

FIG. 31 is a diagram illustrating a window sequence when lpd_mode={3, 3, 3, 3} in a current frame, and lpd_mode={x, x, x, 0} in a previous frame according to an embodiment of the present invention;

FIG. 32 is a diagram illustrating window sequences based on lpd_mode=0 (ACELP) of a previous sub-frame and a next sub-frame, (a) when lpd_mode=1 (TCX 256), (b) when lpd_mode=2 (TCX 512), and (c) when lpd_mode=3 (TCX 1024);

FIG. 33 is a diagram illustrating a window sequence when an LPD mode of a current sub-frame is 1 (TCX 256) and an LPD mode of a previous sub-frame is 0 according to an embodiment of the present invention;

FIG. 34 is a diagram illustrating a window sequence when an LPD mode of a current sub-frame is 2 (TCX 512) and an LPD mode of a previous sub-frame is 0 according to an embodiment of the present invention;

FIG. 35 is a diagram illustrating a window sequence when an LPD mode of a current sub-frame is 3 (TCX 1024) and an LPD mode of a previous sub-frame is 0 according to an embodiment of the present invention;

FIG. 36 is a diagram illustrating results where the window sequences of FIGS. 33 through 35 are combined;

FIG. 37 is a diagram illustrating a window sequence when mode switching occurs according to an embodiment of the present invention;

FIG. 38 is a diagram illustrating a result of change of ‘LPD_START_SEQUENCE’ and ‘STOP_{—}1152_SEQUENCE’ of FIG. 3 according to an embodiment of the present invention;

FIG. 39 is a diagram illustrating a window sequence when mode switching occurs in a conventional art;

FIG. 40 is a diagram illustrating an overall configuration of a USAC for generating a bitstream including a transition according to an embodiment of the present invention;

FIG. 41 is a diagram illustrating a process of adjusting an overlap area of a window when a transition is generated in a boundary of a frame corresponding to a TCX 80 according to an embodiment of the present invention;

FIG. 42 is a diagram illustrating a process of adjusting an overlap area of a window when a transition is generated in a boundary of a frame corresponding to a TCX 20 according to an embodiment of the present invention;

FIG. 43 is a diagram illustrating a process of adjusting a length of an overlap area of a window based on a transition when the overlap area has a length of 256, according to an embodiment of the present invention;

FIG. 44 is a diagram illustrating a process of adjusting a length of an overlap area of a window based on a transition when the overlap area has a length of 512, according to an embodiment of the present invention;

FIG. 45 is a diagram illustrating a process of adjusting a length of an overlap area of a window based on a transition when the overlap area has a length of 1024, according to an embodiment of the present invention;

FIG. 46 is a diagram illustrating an overall configuration of a USAC that uses a bitstream including a transition, according to an embodiment of the present invention;

FIG. 47 is a diagram illustrating an overall configuration of a USAC that utilizes a transition extracted from an encoding result according to another embodiment of the present invention;

FIG. 48 is a diagram illustrating an overall configuration of a USAC that utilizes a transition extracted from a decoding result according to another embodiment of the present invention;

FIG. 49 is a diagram illustrating an actual applicable example of FIG. 47;

FIG. 50 is a diagram illustrating an actual applicable example of FIG. 48;

FIG. 51 is a diagram illustrating a process of applying a transition extracted through a Spectral Band Replication (SBR) decoding scheme to a core band decoding scheme;

FIG. 52 is a diagram illustrating window sequences where overlap areas of windows have a same length, regardless of an LPD mode;

FIG. 53 is a diagram illustrating window sequences where overlap areas of windows have relatively long lengths, in comparison with FIG. 52; and

FIG. 54 is a diagram illustrating a result of applying, to a window sequence, a scheme of adjusting a length of an overlap area of a window based on a transition.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

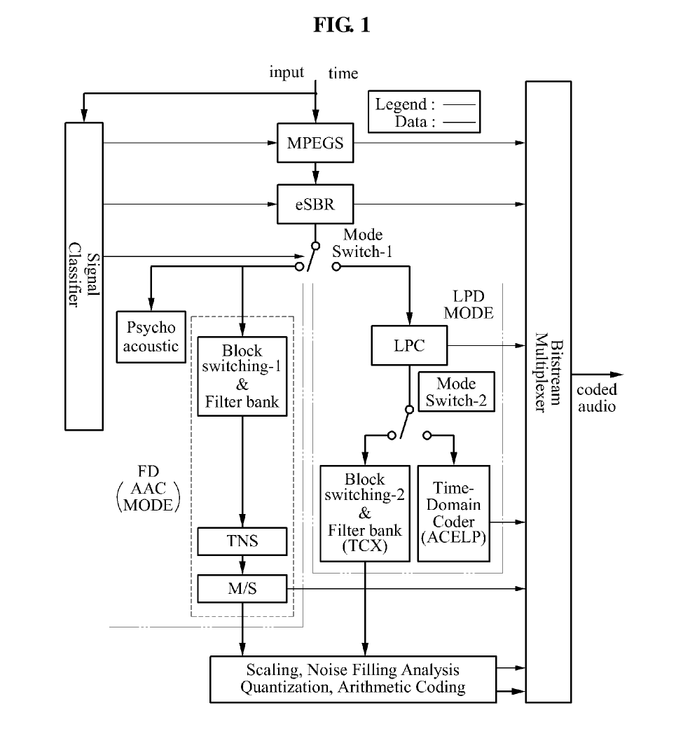

FIG. 1 is a block diagram illustrating a configuration of a Unified Speech and Audio Codec (USAC) according to an embodiment of the present invention.

The USAC of FIG. 1 may perform different encoding methods depending on a characteristic of an input signal, and thereby may improve an encoding performance and a sound quality. For example, the USAC may encode a signal, which is similar to a speech from among input signals, based on a Code Excited Linear Prediction (CELP), and thereby may improve a coding efficiency. Also, the USAC may encode a signal, similar to an audio from among input signals, and thereby may improve a coding efficiency.

In FIG. 1, a Moving Picture Experts Groups Surrounds (MPEGs) may be used to code a stereo signal, and perform One-To-Two (OTT) of an MPEG Surround. Also, an enhanced Spectral Band Replication (eSBR) may extend a bandwidth of the input signal by analyzing a high frequency component. A Mode switch-1 may correspond to a signal classifier, and determine whether a current frame of the input signal is a speech signal or an audio signal. Here, a signal analyzer may determine whether the input signal is similar to the speech signal or the audio signal, and select an encoding depending on the characteristic of the signal. It may be assumed that the USAC includes the signal analyzer which is ideally operated.

When the current frame of the input signal is determined to be similar to the audio, the Mode switch-1 may switch the current frame to an Advanced Audio Coding mode (AAC MODE) which is a Frequency Domain (FD) mode. Also, the current frame may be encoded based on the AAC-MODE. In the ACC-MODE, the input signal may be basically encoded according to a psychoacoustic model. Also, a Blocks witching-1 may differently apply a window to the current frame depending on the characteristic of the input signal. In this instance, the window may be determined based on a coding mode of a previous frame or a next frame. A filter bank may perform Time to Frequency (T/F) transform with respect to the current frame where the window is applied. The filter bank may perform encoding by basically applying a Modified Discrete Cosine Transform (MDCT) to improve an encoding efficiency.

Conversely, when it is determined that the current frame of the input signal is similar to the speech, the Mode switch-1 may switch the current frame into a Linear Prediction Domain mode (LPD MODE). The current frame may be encoded based on a Linear Prediction Coding (LPC). When mode switching occurs between LPD modes, a Blockswitching-2 may apply a window to each sub-frame depending on the LPD modes. In an Enhanced Adaptive Multi-Rate Wideband (AMR-WB+) or USAC, the current frame of the input signal may include four sub-frames in an LPD mode. Here, the current frame of the input signal may be defined as a super-frame signal. A window sequence according to an embodiment of the present invention may be defined as a combined window of at least one window which is applied to sub-frames included in a super-frame.

For example, when a super-frame is processed as a single sub-frame, lpd_mode, that is, an LPD mode of the super-frame may be determined to be {3, 3, 3, 3}. In this instance, a window sequence may include a single window. When the super-frame is processed as two sub-frames, the LPD mode of the super-frame may be determined to be {2, 2, 2, 2}. In this instance, the window sequence may include two windows. When the super-frame is processed as four sub-frames, the LPD mode of the super-frame may be determined to be {1, 1, 1, 1}. In this instance, the window sequence may include four windows.

When lpd_mode=0, a single sub-frame may be encoded based on an Algebraic Code Excited Linear Prediction (ACELP). When an ACELP is applied, a T/F transform and a window may not be applied. That is, encoding according to an LPC-based LPD mode may be performed using a Transform Code eXcitation (TCX) block based on the filter bank and an ACELP block based on a time domain coding. A filter bank method may include an MDCT and a Discrete Fourier Transform (DFT) method. According to an embodiment of the present invention, an MDCT-based TCX may be used. A method of processing a window sequence in the Blockswitching-1 and the Blockswitching-2 is described in detail.

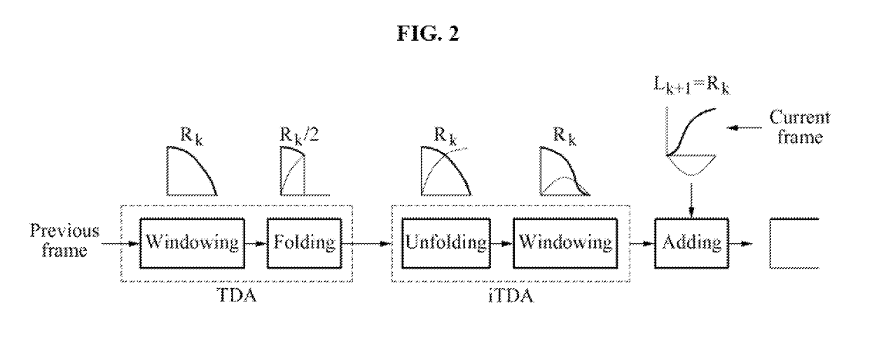

FIG. 2 is a diagram illustrating an MDCT-based Time Domain Aliasing Cancellation (TDAC).

An MDCT may be a T/F transform which is widely used for an audio encoder. In the MDCT, a bit rate may not increase even when an overlap-add is performed among frames. However, since the MDCT may generate an aliasing in a time domain, the MDCT may be a TDAC transform that may restore the input signal after the input signal is inverse-transformed from a frequency domain to a time domain, and then 50% overlap-add is performed with respect to a window and a frame adjacent to a current frame.

Referring to FIG. 2, the MDCT may be performed with respect to the input signal after windowing. When the MDCT is performed, an aliasing may be generated in the time domain. In FIG. 2, Rₖ may denote a right portion of a window applied to the input signal. When the MDCT is performed with respect to the input signal, folding may be performed based on Rₖ/2, and thus a Time Domain Aliasing (TDA) may be generated. Subsequently, when an Inverse MDCT (IMDCT) is performed with respect to the input signal, the window may be unfolded to Rₖ. After TDA is generated, the unfolded window may be different from an initial window.

However, after windowing-MDCT-IMDCT-windowing is performed with respect to a next frame like the current frame, when an overlap-add is performed with respect to a left signal of the next frame where the window is applied and a right signal of the current frame where the window is applied, the input signal where the TDA is canceled may be extracted. The above-described overlap-add may be used to cancel the aliasing in a TDA condition. To apply the overlap-add and TDAC, a point where frames where a window is applied are overlap-added may be a point where the window is folded. In this instance, the folding point may be Rₖ.

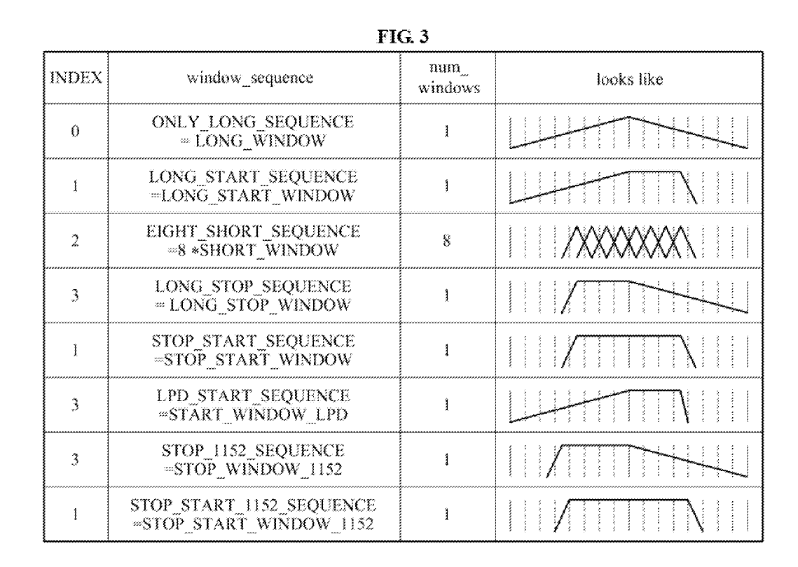

FIG. 3 is a diagram illustrating a window sequence defined in a Reference Model (RM) in a conventional art.

FIG. 3 illustrates the window applicable to the Blockswitching-1 of FIG. 1. In an index 2 of FIG. 3, eight SHORT_WINDOWs are included in a single set, and thereby may be represented as a window sequence. In another transform mode, a single window may be included in a single window sequence. As illustrated in FIG. 3, a window sequence is represented under assumptions of a triangle window. When N, a length of a current frame, is set as 2048, intervals between dotted lines may be 128. However, in ‘STOP_START_{—}1152_SEQUENCE’, the length of the current frame may be set as 2304.

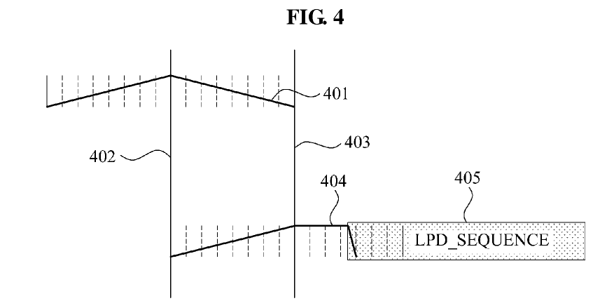

FIG. 4 is a diagram illustrating a window sequence ‘CASE 1: ONLY_LONG_SEQUENCE to LPD_START_SEQUENCE’.

According to an RM of USAC, ‘ONLY_LONG_SEQUENCE’ 401 may be defined to appear prior to ‘LPD_START_SEQUENCE’ 404, and ‘LPD_START_SEQUENCE’ 404 may appear prior to ‘LPD_SEQUENCE’. Here, ‘LPD_SEQUENCE’ may appear in a region 405.

‘LPD_SEQUENCE’ may indicate a window sequence where an LPD mode is applied. Here, a region between a line 402 and a line 403 may indicate a region where two neighboring window sequences are overlap-added when an input signal is restored by a decoder.

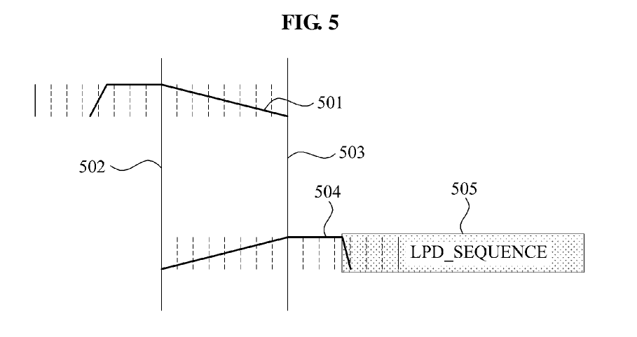

FIG. 5 is a diagram illustrating a window sequence ‘CASE 2: LONG_STOP_SEQUENCE to LPD_START_SEQUENCE’.

According to an RM of USAC, ‘LONG_STOP_SEQUENCE’ 501 may be defined to appear prior to ‘LPD_START_SEQUENCE’ 504, and ‘LPD_START_SEQUENCE’ 504 may appear prior to ‘LPD_SEQUENCE’. Here, ‘LPD_SEQUENCE’ may appear in a region 505.

As FIG. 4, ‘LPD_SEQUENCE’ may indicate a window sequence generated in an LPD mode. Here, a region between a line 502 and a line 503 may indicate a region where two neighboring windows are overlap-added when an input signal is restored by a decoder.

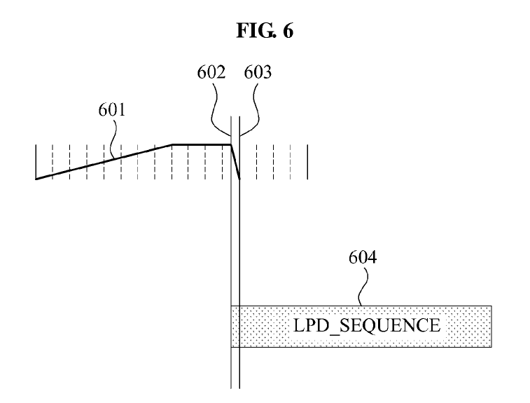

FIG. 6 is a diagram illustrating a window sequence ‘CASE 3: LPD_START_SEQUENCE to LPD_SEQUENCE’ when mode switching occurs from a FD to an LPD mode.

According to an RM of USAC, ‘LPD_START_SEQUENCE’ 601 may be defined to appear prior to ‘LPD_SEQUENCE’. ‘LPD_START_SEQUENCE’ 601 may indicate a last window where an AAC MODE is applied, when mode switching occurs from the AAC MODE to an LPC MODE in a Mode switch-1. Here, the ACC MODE may be a FD mode, and the LPC MODE may be an LPD mode. ‘LPD_SEQUENCE’ may appear in a region 604.

As FIG. 4, ‘LPD_SEQUENCE’ may indicate a window sequence where the LPD mode is applied. Here, a region between a line 602 and a line 603 may indicate a region where two neighboring window sequences are overlap-added when an input signal is restored by a decoder. In this instance, a size of regions where a window sequence is overlap-added may be 64 points.

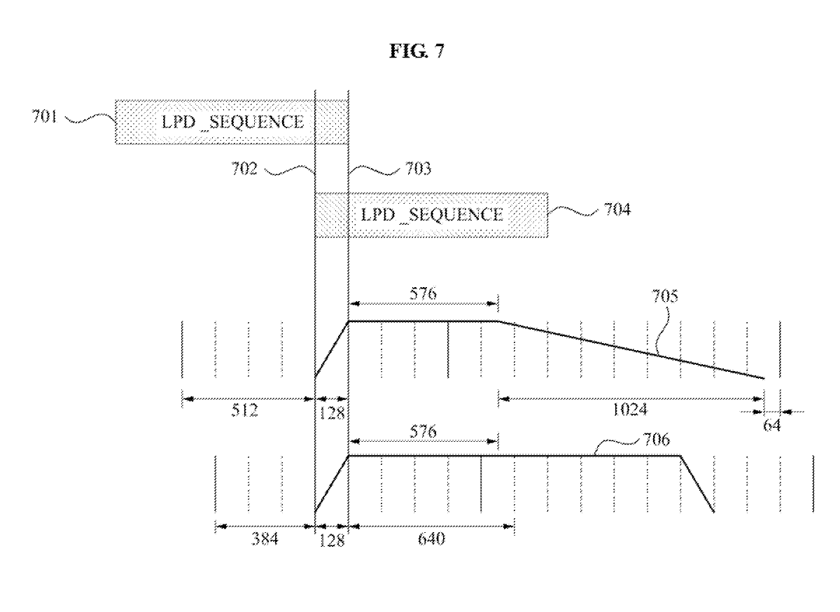

FIG. 7 is a diagram illustrating a window sequence ‘CASE 4: LPD_SEQUENCE to LPD_SEQUENCE’ when mode switching occurs from an LPD mode to an LPD mode, and a window sequence ‘CASE 4: LPD_SEQUENCE to STOP_{—}1152_SEQUENCE or STOP_START_{—}1152_SEQUENCE’ when mode switching occurs from an LPD mode to a FD mode.

According to an RM of USAC, ‘LPD_SEQUENCE’ where the LPD mode is applied may be defined to appear in a region 701 and another ‘LPD_SEQUENCE’ may appear in a region 704. In FIG. 7, a region where ‘LPD_SEQUENCE’ and another ‘LPD_SEQUENCE’ are overlap-added may be between a line 702 and a line 703. A size of the overlap-added region may be 128 points.

Also, as illustrated in FIG. 7, ‘LPD_SEQUENCE’ where the LPD mode is applied may appear in the region 701, and ‘STOP_{—}1152_SEQUENCE’ 705 where an ACC MODE is applied may appear after ‘LPD_SEQUENCE’. Also, ‘LPD_SEQUENCE’ where the LPD mode is applied may appear in the region 701, and ‘STOP_START_{—}1152_SEQUENCE’ 706 where the ACC MODE is applied may appear after ‘LPD_SEQUENCE’

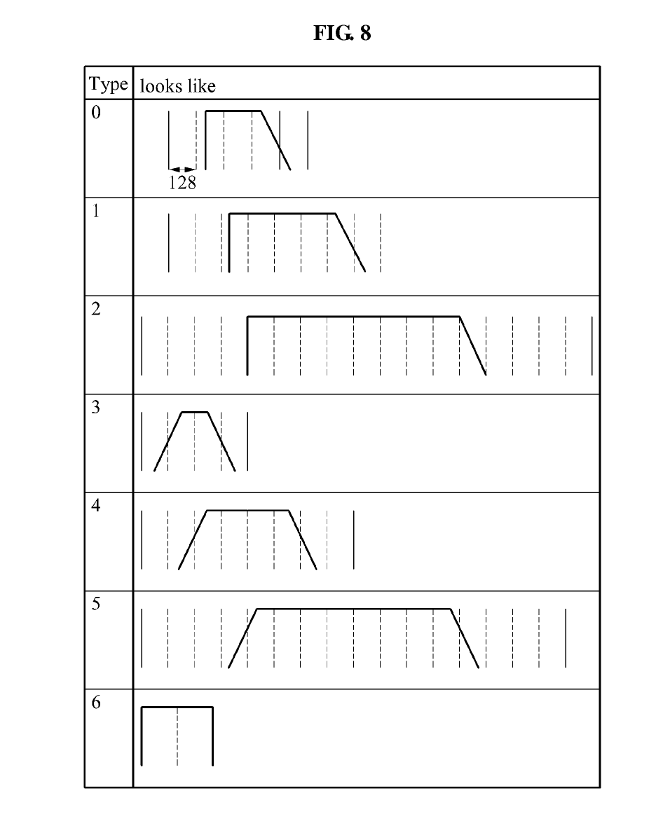

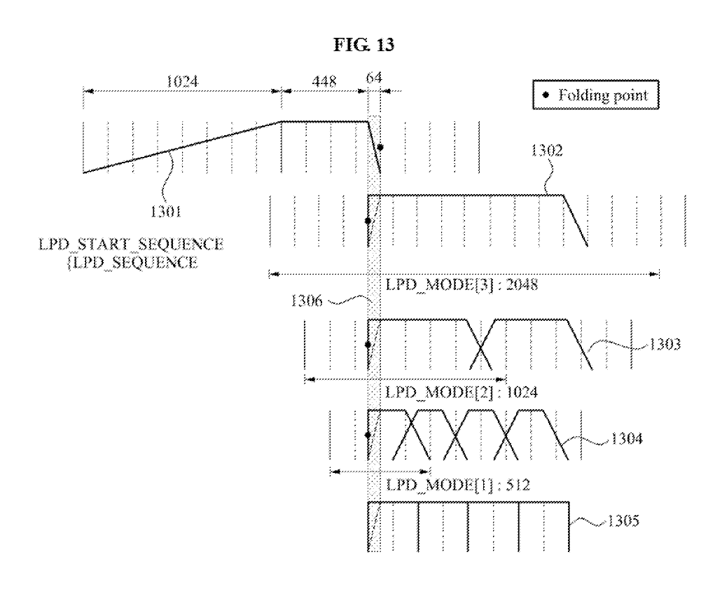

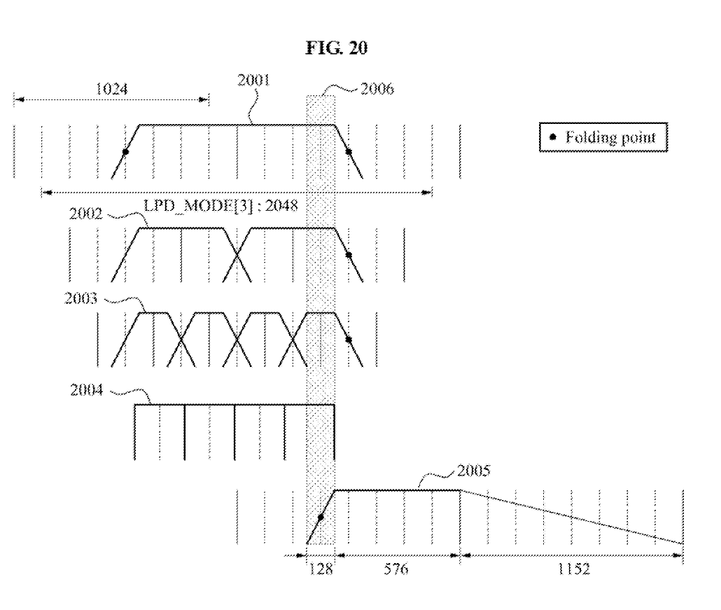

According to an embodiment of the present invention, a window sequence processing method and a method of processing ‘LPD_SEQUENCE’ may be provided with respect to CASE 3 and CASE 4. CASE 3 may be associated with when a FD mode is changed to an LPD mode, which is described in detail with reference to FIGS. 13 through 16. CASE 4 may be associated with when the LPD mode is changed to the FD mode, which is described in detail with reference to FIGS. 20 through 24. ‘LPD_SEQUENCE’ is described in detail with reference to FIGS. 8 through 12. CASE 3 and CASE 4 may be associated with a window sequence processing method when mode switching occurs between the LPD mode and the FD mode. The Blockswitching-1 of FIG. 1 may process a window sequence. Also, ‘LPD_SEQUENCE’ may denote a window sequence when mode switching occurs between LPD modes. The Blockswitching-2 of FIG. 1 may process a window sequence.

In the mode switching between LPD modes, a USAC may include a mode switching unit to perform switching between LPD modes with respect to sub-frames included in a frame of an input signal, and an encoding unit to encode the input signal by applying a window based on the switched LPD mode to a current sub-frame to be coded from among the sub-frames.

In this instance, the mode switching unit may correspond to the Mode switch-2 of FIG. 1, and the encoding unit may correspond to the Blockswitching-2 of FIG. 1. The encoding unit may encode the input signal by applying a window to the current sub-frame. Here, the window may be changed according to an LPD mode of a previous sub-frame and an LPD mode of a next sub-frame. Also, the encoding unit may perform overlap-add between the sub-frames based on a folding point located in a boundary of the sub-frames.

For example, when an LPD mode of the current sub-frame is 1 and the LPD mode of the previous sub-frame or the next sub-frame is different from 0, the encoding unit may perform encoding using the window which is applied to the current sub-frame. Here, the window may include a region which is overlap-added to the previous sub-frame or the next sub-frame, and a size of the region may be 256.

Also, when the LPD mode of the current sub-frame is 2 and the LPD mode of the previous sub-frame or the next sub-frame is different from 0, the encoding unit may perform encoding using the window which is applied to the current sub-frame. Here, the window may include a region which is overlap-added to the previous sub-frame or the next sub-frame, and a size of the region may be 512.

Also, when the LPD mode of the current sub-frame is 3 and the LPD mode of the previous sub-frame or the next sub-frame is different from 0, the encoding unit may perform encoding using the window which is applied to the current sub-frame. Here, the window may include a region which is overlap-added to the previous sub-frame or the next sub-frame, and a size of the region may be 1024.

When the LPD mode of the previous sub-frame is 0, the encoding unit may process a left portion of the window, which is applied to the current sub-frame, as a rectangular shape having a value of 1. When the LPD mode of the next sub-frame is 0, the encoding unit may process a right portion of the window, which is applied to the current sub-frame, as a rectangular region having a value of 1.

In this instance, the encoding unit may perform overlap-add between the sub-frames based on a folding point located in a boundary of the sub-frames.

In the mode switching from the FD mode to the LPD mode, a USAC may include a mode switching unit to switch from a FD mode to an LPD mode with respect to a frame of an input signal, and an encoding unit to perform encoding by performing overlap-add with respect to a window sequence of the FD mode and a window sequence of the LPD mode based on a folding point.

In this instance, when an LPD mode of a starting sub-frame from among the window sequence of the LPD mode is 0, the encoding unit may replace a window corresponding to the starting sub-frame with a window corresponding to an LPD mode of 1.

Also, the encoding unit may shift the window sequence of the LPD mode to enable the window sequence of the LPD mode to be overlap-added to the window sequence of the FD mode based on the folding point.

Also, the encoding unit may change a shape of the window sequence of the FD mode based on the window sequence of the LPD mode.

Also, the encoding unit may perform overlap-add between the window sequences based on the folding point, located in a boundary of sub-frames included in the frame of the input signal, and extract an LPC at every sub-frame by setting the folding point as a starting point.

In the mode switching from the LPD mode to the FD mode, a USAC may include a mode switching unit to switch an LPD mode to a FD mode with respect to a frame of an input signal, and an encoding unit to perform encoding by performing overlap-add with respect to a window sequence of the FD mode and a window sequence of the LPD mode based on a folding point.

Also, the encoding unit may change the window sequence of the FD mode based on the window sequence of the LPD mode.

Also, the encoding unit may overlap the window sequence of the FD mode and the window sequence of the LPD mode by 256 points. Here, when an LPD mode of an end sub-frame from among the window sequence of the LPD mode is 0, a window corresponding to the end sub-frame may be replaced with a window corresponding to an LPD mode of 1.

Here, a USAC (decoding) may process a window sequence in a same way as the USAC (encoding) associated with the mode switching between LPD modes, mode switching from the FD mode to the LPD mode, and mode switching from the LPD mode to the FD mode. Hereinafter, the window sequence to be processed in the USAC (decoding) is described in detail.

FIG. 8 is a diagram illustrating window shapes of ‘LPD_SEQUENCE’ for each type.

FIG. 8 illustrates the windows of ‘LPD_SEQUENCE’ described above with reference to FIGS. 4 through 7. ‘LPD_SEQUENCE’ illustrated in FIG. 8 may be defined in Table 1.

TABLE 1

| | | | Number lg of | | | | | |
|---|---|---|---|---|---|---|---|---|
| | Value of | value of | spectral | | | | | |
| Type | last_lpd_mode | mod[x] | coefficients | ZL | L | M | R | ZR |
| 0 | 0 | 1 | 320 | 160 | 0 | 256 | 128 | 96 |
| 1 | 0 | 2 | 576 | 288 | 0 | 512 | 128 | 224 |
| 2 | 0 | 3 | 1152 | 512 | 128 | 1024 | 128 | 512 |
| 3 | 1 . . . 3 | 1 | 256 | 64 | 128 | 128 | 128 | 64 |
| 4 | 1 . . . 3 | 2 | 512 | 192 | 128 | 384 | 128 | 192 |
| 5 | 1 . . . 3 | 3 | 1024 | 448 | 128 | 896 | 128 | 448 |

Table 1 defines a window shape of ‘LPD_SEQUENCE’ with respect to a current sub-frame that may change based on lpd_mode (last_lpd_mode) of a previous sub-frame. In Table 1, ZL may denote a length of a section corresponding to a zero block inserted in a left portion of the window in ‘LPD_SEQUENCE’. Also, ZR may denote a length of a section corresponding to a zero block inserted in a right portion of the window in ‘LPD_SEQUENCE’. M may denote a length of a period of a window having a value of ‘1’ in ‘LPD_SEQUENCE’. Also, L and R may denote a length of a section which is overlap-added to a window adjacent to each of a left portion and a right portion in ‘LPD_SEQUENCE’. Here, the left portion and right portion may be divided based on a center point of each window. As shown in Table 1, 1024 or 1152 spectral coefficients may be generated with respect to a single frame.

When lpd_mode=0, ‘LPD_SEQUENCE’ of the current sub-frame may indicate a window of type 6 in FIG. 8, regardless of lpd_mode of the previous sub-frame. Here, the window of type 6 may be a rectangular window without a zero block. That is, when lpd_mode=0, an input signal may be encoded based on an ACELP. Also, when the input signal is restored, aliasing may not be generated, and a window for overlap-add may not be applied. Accordingly, an ACELP block of FIG. 1 may not perform block-switching differently from a TCX block.

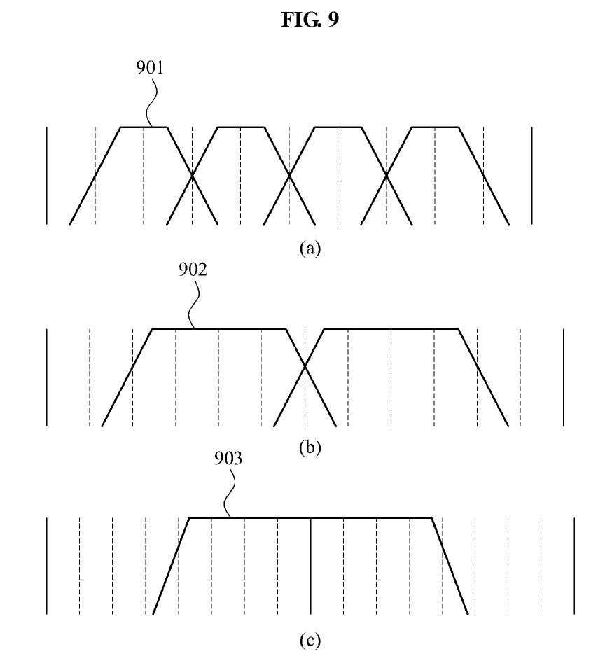

Referring to FIG. 8, 26 types of ‘LPD_SEQUENCE’ may be generated with respect to a single super-frame. FIGS. 9 through 12 illustrate a portion of 26 types of ‘LPD_SEQUENCE’ that may be generated.

FIG. 9 is a diagram illustrating ‘LPD_SEQUENCE’ (a) when an LPD mode is {1, 1, 1, 1}, (b) when an LPD mode is {2, 2, 2, 2}, and (c) when an LPD mode is {3, 3, 3, 3}.

FIG. 9 (a) illustrates ‘LPD_SEQUENCE’ when lpd_mode of each sub-frame of a super-frame is all ‘1’. In this instance, ‘LPD_SEQUENCE’ of FIG. 9 (a) may include four windows 901 corresponding to a type 3 of FIG. 8. lpd_mode of ‘LPD_SEQUENCE’ of FIG. 9 (a) may be {1, 1, 1, 1}.

FIG. 9 (b) illustrates ‘LPD_SEQUENCE’ when lpd_mode of each sub-frame of a super-frame is all ‘2’. In this instance, ‘LPD_SEQUENCE’ of FIG. 9 (b) may include two windows 902 corresponding to a type 4 of FIG. 8. lpd_mode of ‘LPD_SEQUENCE’ of FIG. 9 (b) may be {2, 2, 2, 2}.

FIG. 9 (c) illustrates ‘LPD_SEQUENCE’ when lpd_mode of each sub-frame of a super-frame is all ‘3’. In this instance, ‘LPD_SEQUENCE’ of FIG. 9 (c) may include four windows 903 corresponding to a type 3 of FIG. 8. lpd_mode of ‘LPD_SEQUENCE’ of FIG. 9 (c) may be {3, 3, 3, 3}.

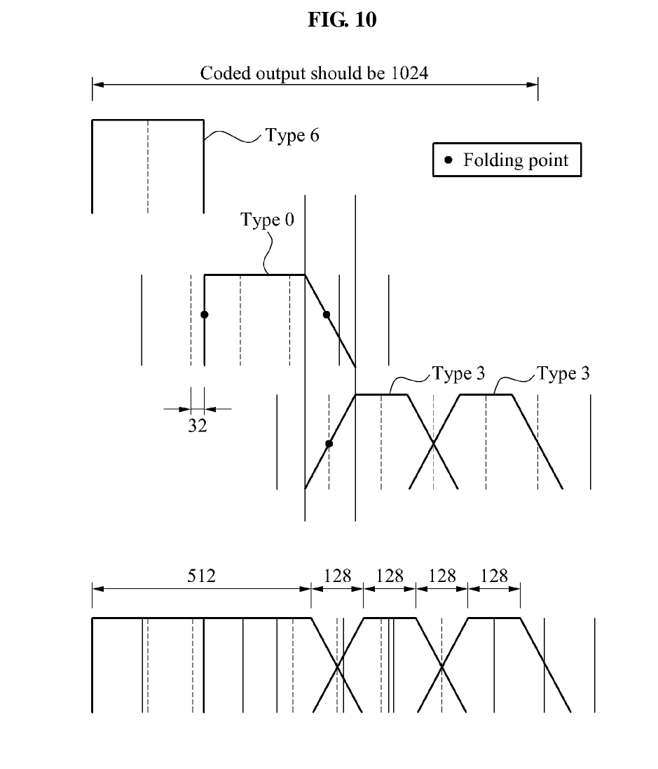

FIG. 10 is a diagram illustrating ‘LPD_SEQUENCE’ when an LPD mode is {0, 1, 1, 1}.

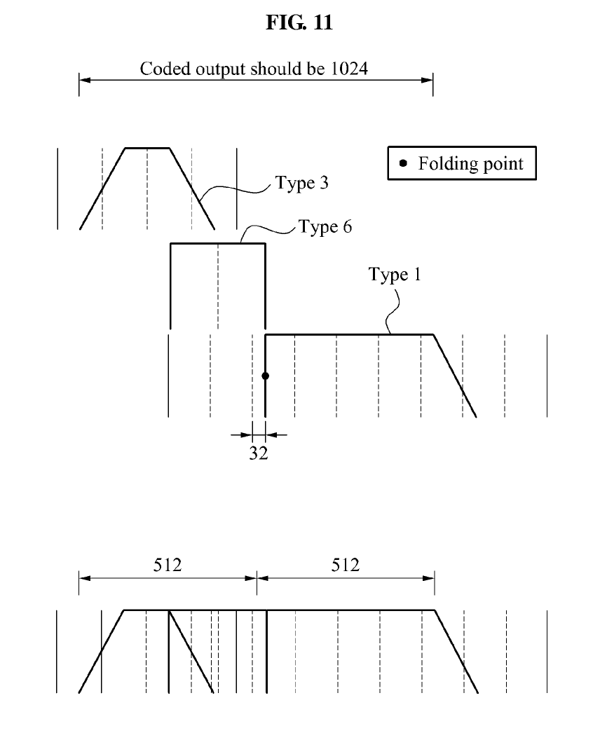

FIG. 11 is a diagram illustrating ‘LPD_SEQUENCE’ when an LPD mode is {1, 0, 2, 2}.

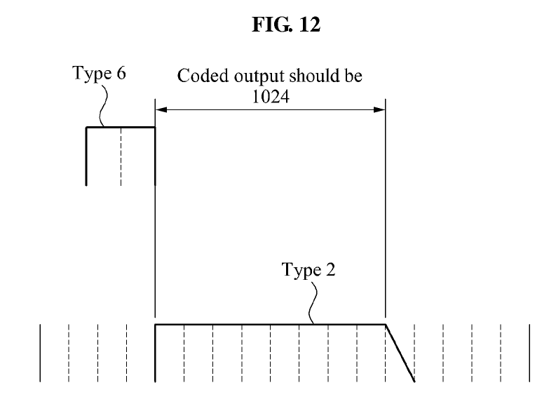

FIG. 12 is a diagram illustrating ‘LPD_SEQUENCE’ where an LPD mode is {3, 3, 3, 3}, when an LPD mode of an end sub-frame of a previous frame is {0}.

FIG. 13 is a diagram illustrating a window sequence processing method with respect to CASE 3 in a conventional art.

As described in FIG. 6, CASE 3 may be associated with when a window sequence processing is performed from ‘LPD_START_SEQUENCE’ 1301 to ‘LPD_SEQUENCE’ 1302, 1303, 1304, and 1305. In this instance, when mode switching occurs from the AAC MODE, which is the FD mode, to the LPC MODE, which is the LPD mode, in the Mode switch-1, ‘LPD_START_SEQUENCE’ 1301 may indicate a window sequence which is finally applied in the AAC MODE.

In FIG. 13, ‘LPD_SEQUENCE’ 1302 may be associated with when lpd_mode={3, 3, 3, 3}. ‘LPD_SEQUENCE’ 1303 may be associated with when lpd_mode={2, 2, 2, 2}. ‘LPD_SEQUENCE’ 1304 may be associated with when lpd_mode={1, 1, 1, 1}. ‘LPD_SEQUENCE’ 1305 may be associated with when lpd_mode={0, 0, 0, 0}. In FIG. 13, ‘LPD_SEQUENCE’ 1302, 1303, 1304, and 1305 may be overlap-added to ‘LPD_START_SEQUENCE’ 1301 based on a folding point at a region 1306 of 64-point after ‘LPD_SEQUENCE’ 1302, 1303, 1304, and 1305 are modified to a dotted line.

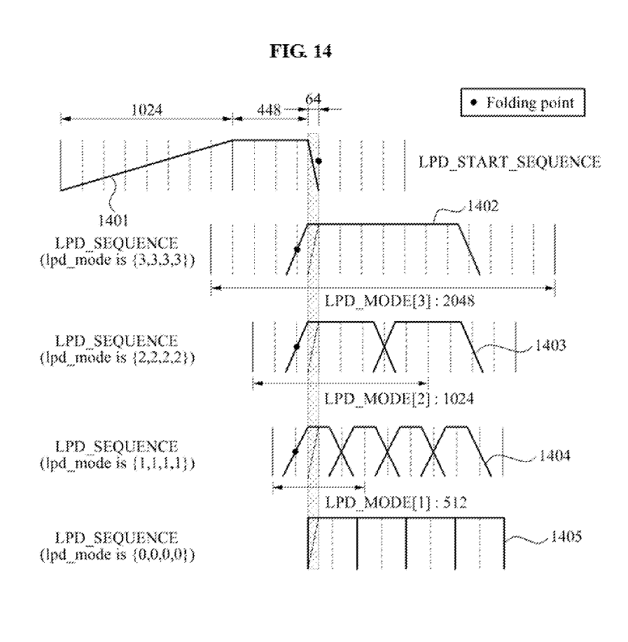

FIG. 14 is a diagram illustrating a first example of a window sequence processing method with respect to CASE 3 according to an embodiment of the present invention.

Referring to FIG. 14, ‘LPD_START_SEQUENCE’ 1401 may be overlap-added to ‘LPD_SEQUENCE’ 1402, 1403, 1404, and 1405 in a region 1406 regardless of TDAC. Accordingly, each ‘LPD_SEQUENCE’ 1402, 1403, 1404, and 1405 may be modified into a dotted line, and overlap-added to ‘LPD_START_SEQUENCE’ 1401 based on a folding point in the region 1406. In this instance, a size of the region 1406 may be 64 points.

The folding point may indicate a point where a window is folded since a TDA is generated, after MDCT and IMDCT are performed. That is, according to an embodiment of the present invention, in a right window of ‘LPD_START_SEQUENCE’ 1401, a TDA may not be generated even when MDCT and IMDCT are performed. Also, the right window of ‘LPD_START_SEQUENCE’ 1401 may be connected to a neighboring frame through overlap-adding after windowing.

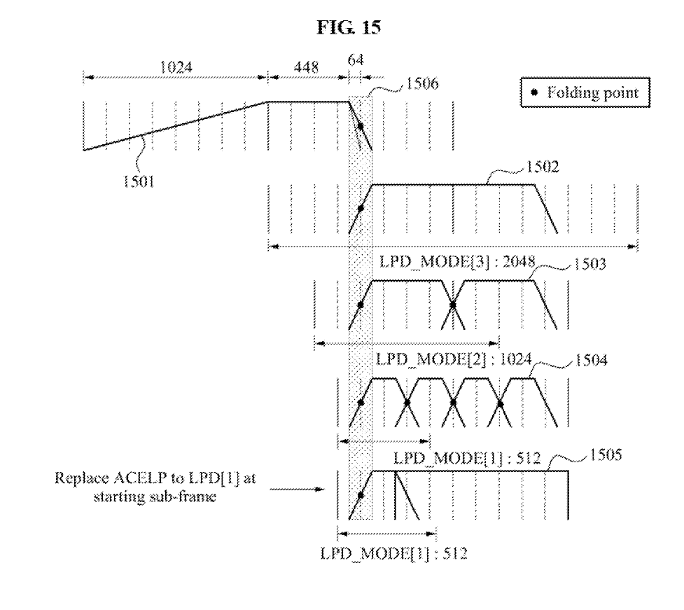

FIG. 15 is a diagram illustrating a second example of a window sequence processing method with respect to CASE 3 according to an embodiment of the present invention.

‘LPD_SEQUENCE’ 1502, 1503, 1504, and 1505, illustrated in FIG. 15, may be shifted by 128 points in a right direction than ‘LPD_SEQUENCE’ 1402, 1403, 1404, and 1405 of FIG. 14. That is, ‘LPD_SEQUENCE’ 1502, 1503, 1504, and 1505 may be overlap-added to ‘LPD_START_SEQUENCE’ 1501 based on a folding point without modification, differently from ‘LPD_SEQUENCE’ 1402, 1403, 1404, and 1405. Also, a size of an overlap-added region 1506 may be 128 points, which is greater than the region 1406 by 64 points. Also, ‘LPD_SEQUENCE’ 1502, 1503, 1504, and 1505 may be shifted by 64 points in a right direction than ‘LPD_SEQUENCE’ 1302, 1303, 1304, and 1305 of FIG. 13. In this instance, when lpd_mode of ‘LPD_SEQUENCE’ 1505 is {0, 0, 0, 0}, lpd_mode of a starting sub-frame of ‘LPD_SEQUENCE’ 1505 may be changed to ‘1’.

Referring to FIG. 15, when the Mode switching-1 performs mode switching from the AAC MODE to the LPD MODE, a window sequence of the AAC MODE, that is, ‘LPD_START_SEQUENCE’ 1501, may be connected to window sequences of the LPD MODE, that is, ‘LPD_SEQUENCE’ 1502, 1503, 1504, and 1505, based on an MDCT folding point. That is, ‘LPD_SEQUENCE’ 1502, 1503, 1504, and 1505 may be overlap-added to ‘LPD_START_SEQUENCE’ 1501 based on a TDA folding point in the region 1506, and thus an aliasing generated in a time domain may be canceled.

Accordingly, ‘LPD_SEQUENCE’ 1502, 1503, 1504, and 1505 may be shifted by 64 points in a right direction than ‘LPD_SEQUENCE’ 1302, 1303, 1304, and 1305, and be overlap-added. Also, ‘LPD_SEQUENCE’ 1502, 1503, 1504, and 1505 may be shifted by 128 points in a right direction in comparison with ‘LPD_SEQUENCE’ 1402, 1403, 1404, and 1405, and be overlap-added. That is, the window sequence processing in FIG. 15 may obtain a coding gain, which is greater than by 64 points when compared to the window sequence processing in FIG. 13, and which is greater than by 128 points when compared to the window sequence processing in FIG. 14, every time the Mode switch-1 of FIG. 1 performs mode switching from the FD mode to the LPD mode.

Accordingly, the window sequence processing method with respect to CASE 3 may be as follows:
(1) the window sequence ‘LPD_START_SEQUENCE’ of the FD mode and window sequence ‘LPD_SEQUENCE’ of the LPD mode may be overlap-added based on an MDCT folding point.
(2) a shape of a window corresponding to a region connected to ‘LPD_SEQUENCE’ in ‘LPD_START_SEQUENCE’ may be required to be changed to pass a folding point.
(3) a starting location of ‘LPD_SEQUENCE’ may be required to be shifted to be matched with an MDCT folding point by 64 points compared to ‘LPD_SEQUENCE’ of FIG. 13 and by 128 points compared to ‘LPD_SEQUENCE’ of FIG. 14.
(4) exceptionally, in ‘LPD_SEQUENCE’ starting from an ACELP sub-frame, the ACELP sub-frame may be replaced with a TCX20 (lpd_mode={1}).

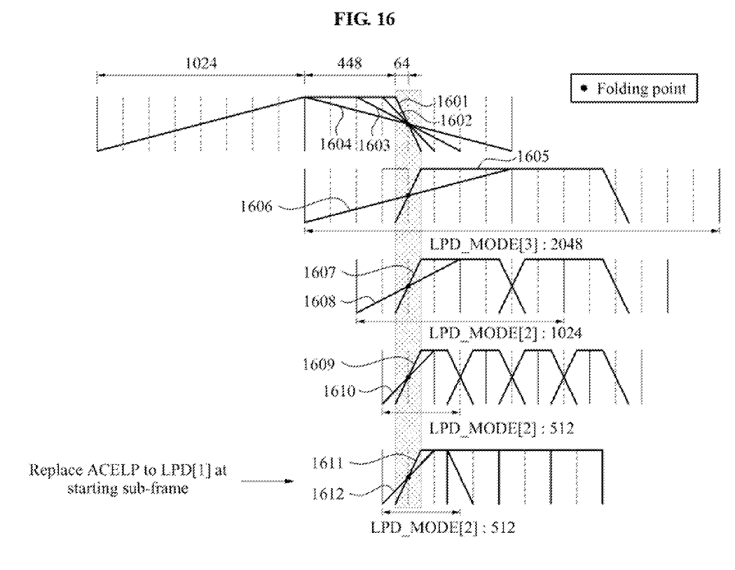

FIG. 16 is a diagram illustrating a third example of a window sequence processing method with respect to CASE 3 according to an embodiment of the present invention.

FIG. 16 illustrates a change of a window in a region which is overlap-added to ‘LPD_SEQUENCE’ in ‘LPD_START_SEQUENCE’ based on an LPD mode of ‘LPD_SEQUENCE’ of a next frame. That is, a shape of a right window of ‘LPD_START_SEQUENCE’ may be changed based on the LPD mode of ‘LPD_SEQUENCE’. In FIG. 16, when the right window of ‘LPD_START_SEQUENCE’ is a line 1601, ‘LPD_START_SEQUENCE’ of FIG. 16 may have a same shape as ‘LPD_START_SEQUENCE’ 1501.

When an LPD mode of ‘LPD_SEQUENCE’ corresponding to a next frame is {3, 3, 3, 3}, a shape of a right window of ‘LPD_START_SEQUENCE’ corresponding to a current frame may change to a line 1604. Also, since the right window of ‘LPD_START_SEQUENCE’ changes, a left window of ‘LPD_SEQUENCE’ where the LPD mode is {3, 3, 3, 3} may change from a line 1605 to a line 1606. Accordingly, ‘LPD_START_SEQUENCE’ and ‘LPD_SEQUENCE’ may be overlap-added by 1024 points.

When an LPD mode of ‘LPD_SEQUENCE’ corresponding to a next frame is {2, 2, x, x}, a shape of a right window of ‘LPD_START_SEQUENCE’ corresponding to a current frame may change to a line 1603. Also, since the right window of ‘LPD_START_SEQUENCE’ changes, a left window of ‘LPD_SEQUENCE’ where the LPD mode is {2, 2, x, x} may change from a line 1607 to a line 1608. Accordingly, ‘LPD_START_SEQUENCE’ and ‘LPD_SEQUENCE’ may be overlap-added by 512 points.

When an LPD mode of ‘LPD_SEQUENCE’ corresponding to a next frame is {1, x, x, x}, a shape of a right window of ‘LPD_START_SEQUENCE’ corresponding to a current frame may change to a line 1602. Also, since the right window of ‘LPD_START_SEQUENCE’ changes, a left window of ‘LPD_SEQUENCE’ where the LPD mode is {1, x, x, x} may change from a line 1609 to a line 1610. Accordingly, ‘LPD_START_SEQUENCE’ and ‘LPD_SEQUENCE’ may be overlap-added by 1024 points.

When an LPD mode of ‘LPD_SEQUENCE’ corresponding to a next frame is {0, x, x, x}, an LPD mode of a starting sub-frame of ‘LPD_SEQUENCE’ may be replaced with ‘1’. In this instance, similarly to when the LPD mode of ‘LPD_SEQUENCE’ is {1, x, x, x}, the shape of the right window of ‘LPD_START_SEQUENCE’ corresponding to a current frame may change to the line 1602. Also, since the right window of ‘LPD_START_SEQUENCE’ changes, a left window of ‘LPD_SEQUENCE’ where the LPD mode is {0, x, x, x} may change from a line 1611 to a line 1612. Accordingly, ‘LPD_START_SEQUENCE’ and ‘LPD_SEQUENCE’ may be overlap-added by 512 points.

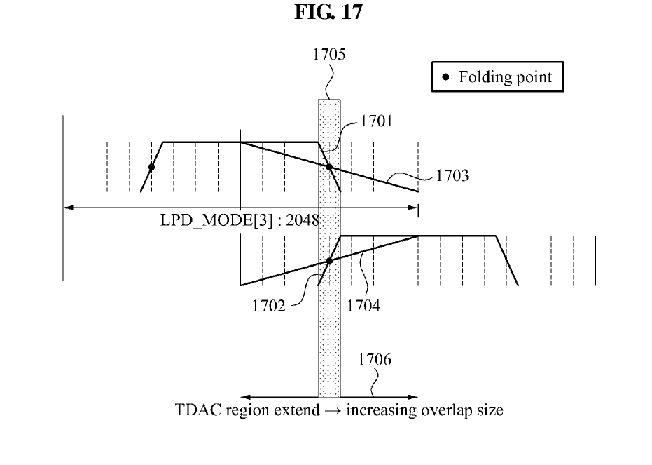

FIG. 17 is a diagram illustrating a window when an LPD mode of ‘LPD_SEQUENCE’ with respect to a current sub-frame is 3, and an LPD mode of ‘LPD_SEQUENCE’ with respect to a next sub-frame is 3 according to an embodiment of the present invention.

Referring to FIG. 17, when the LPD mode of ‘LPD_SEQUENCE’ with respect to the next sub-frame is 3, a right window of ‘LPD_SEQUENCE’ with respect to the current sub-frame may change from a line 1701 to a line 1703. Also, a left window of ‘LPD_SEQUENCE’ corresponding to the next sub-frame may change from a line 1702 to a line 1704. Accordingly, a region 1705 where window sequences are overlap-added based on a folding point may be extended to a region 1706.

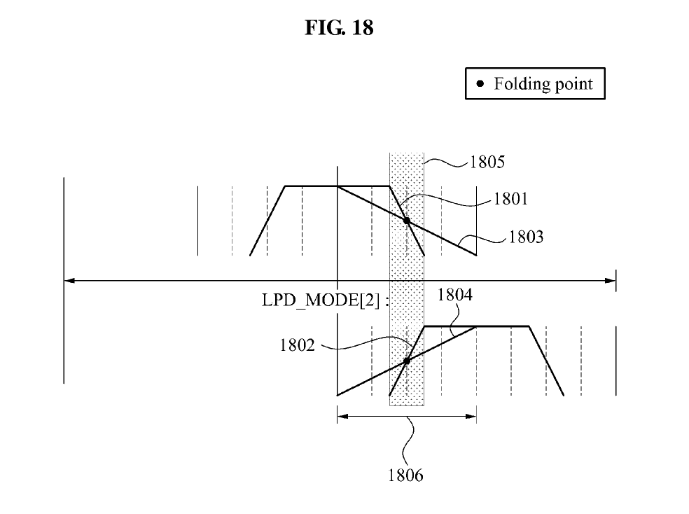

FIG. 18 is a diagram illustrating a window when an LPD mode of ‘LPD_SEQUENCE’ with respect to a current sub-frame is 2, and an LPD mode of ‘LPD_SEQUENCE’ with respect to a next sub-frame is 2 according to an embodiment of the present invention.

Referring to FIG. 18, when the LPD mode of ‘LPD_SEQUENCE’ with respect to the next sub-frame is 2, a right window of ‘LPD_SEQUENCE’ with respect to the current sub-frame may change from a line 1801 to a line 1803. Also, a left window of ‘LPD_SEQUENCE’ corresponding to the next sub-frame may change from a line 1802 to a line 1804. Accordingly, a region 1805 where window sequences are overlap-added based on a folding point may be extended to a region 1806.

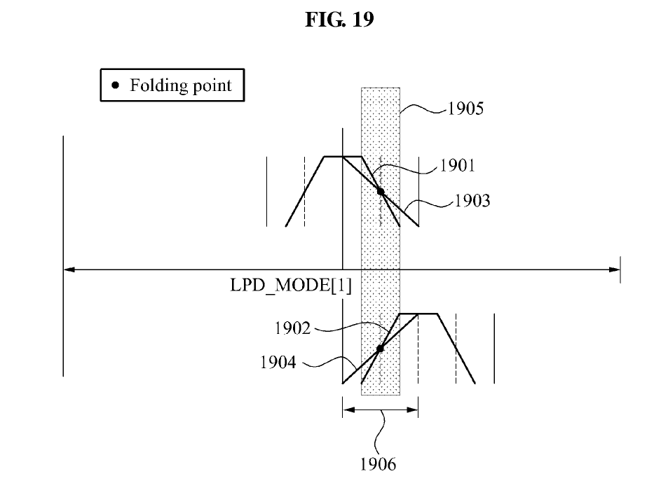

FIG. 19 is a diagram illustrating a window when an LPD mode of ‘LPD_SEQUENCE’ with respect to a current sub-frame is 1, and an LPD mode of ‘LPD_SEQUENCE’ with respect to a next sub-frame is 1 according to an embodiment of the present invention.

Referring to FIG. 19, when the LPD mode of ‘LPD_SEQUENCE’ with respect to the next sub-frame is 1, a right window of ‘LPD_SEQUENCE’ with respect to the current sub-frame may change from a line 1901 to a line 1903. Also, a left window of ‘LPD_SEQUENCE’ corresponding to the next sub-frame may change from a line 1902 to a line 1904. Accordingly, a region 1905 where window sequences are overlap-added based on a folding point may be extended to a region 1906.

FIG. 20 is a diagram illustrating a window sequence processing method with respect to CASE 4 in a conventional art.

Referring to FIG. 20, each ‘LPD_SEQUENCE’ 2001, 2002, 2003, and 2004 may be overlapped a window sequence 2005 of an AAC MODE with respect to a region where a TDA is not generated at a region 2006. Each ‘LPD_SEQUENCE’ 2001, 2002, 2003, and 2004 may be generated an artificial TDA in the region 2006, and may be added to the window sequence 2005.

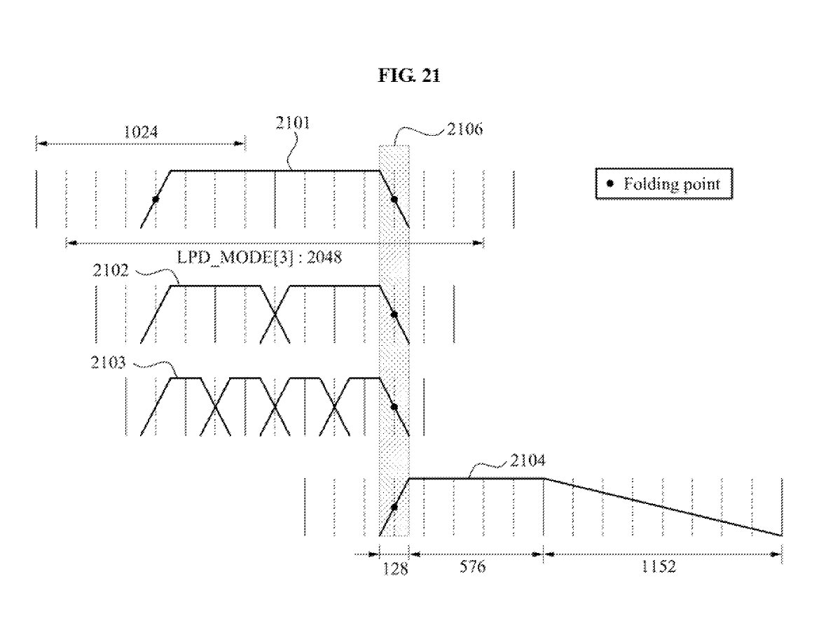

FIG. 21 is a diagram illustrating a first example of a window sequence processing method with respect to CASE 4 according to an embodiment of the present invention.

FIG. 21 illustrates a window sequence processed by a Blockswitching-1 when the Mode switch-1 of FIG. 1 perform mode switching from an LPD mode to a FD mode like CASE 4. As illustrated in FIG. 21, the Blockswitching-1 may perform overlap-add with respect to a window sequence 2104 and each ‘LPD_SEQUENCE’ 2101, 2102, and 2103, based on a folding point in a region 2106 where a TDA is generated. Accordingly, an aliasing may be canceled. Here, the window sequence 2104 may correspond to a FD mode, and each ‘LPD_SEQUENCE’ 2101, 2102, and 2103 may correspond to an LPD mode.

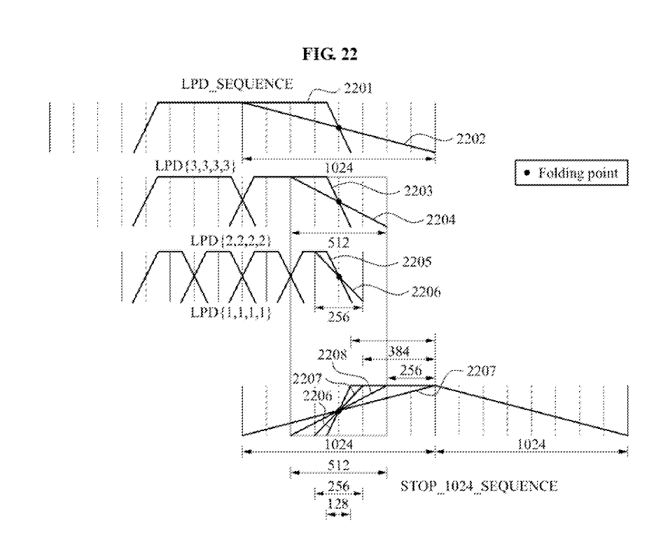

FIG. 22 is a diagram illustrating a second example of a window sequence processing method with respect to CASE 4 according to an embodiment of the present invention.

Referring to FIG. 22, a left window of ‘STOP_{—}1024_SEQUENCE’ corresponding to a current frame may change based on an LPD mode of ‘LPD_SEQUENCE’ of a previous frame. For example, when the LPD mode of ‘LPD_SEQUENCE’ of the previous frame is {3, 3, 3, 3}, a left window of ‘STOP_{—}1024_SEQUENCE’ corresponding to the current frame may be changed to a line 2208. Also, when the LPD mode of ‘LPD_SEQUENCE’ of the previous frame is {1, 1, 1, 1}, the left window of ‘STOP_{—}1024_SEQUENCE’ corresponding to the current frame may be changed to a line 2209. A line 2210 may indicate a left window of ‘STOP_{—}1024_SEQUENCE’ of FIG. 21.

Subsequently, since the left window of ‘STOP_{—}1024_SEQUENCE’ changes, a right window of ‘LPD_SEQUENCE’ may change. That is, when the left window of ‘STOP_{—}1024_SEQUENCE’ is changed to a line 2207, the right window of ‘LPD_SEQUENCE’ may change from a line 2201 to a line 2202. Also, when the left window of ‘STOP_{—}1024_SEQUENCE’ is changed to a line 2208, the right window of ‘LPD_SEQUENCE’ may change from a line 2203 to a line 2204. Also, when the left window of ‘STOP_{—}1024_SEQUENCE’ is changed to a line 2209, the right window of ‘LPD_SEQUENCE’ may change from a line 2205 to a line 2206.

Accordingly, the changed ‘LPD_SEQUENCE’ and the changed ‘STOP_{—}1024_SEQUENCE’ may be overlap-added based on a folding point.

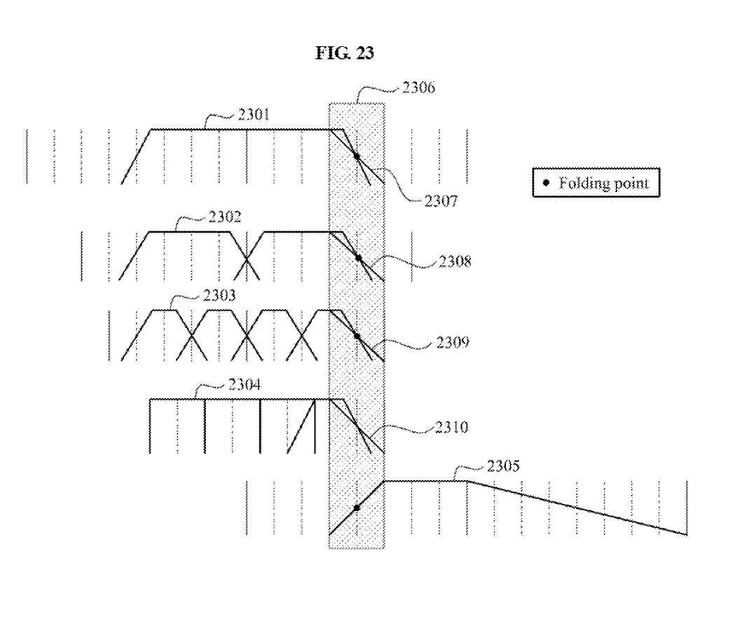

FIG. 23 is a diagram illustrating a third example of a window sequence processing method with respect to CASE 4 according to an embodiment of the present invention.

In FIG. 23, a window sequence corresponding to a FD mode may be ‘STOP_{—}1024_SEQUENCE’ 2305. Referring to FIG. 23, a right window of each ‘LPD_SEQUENCE’ 2301, 2302, 2303, and 2304 may change a line 2307, 2308, 2309, and 2310, respectively. The Mode switching-1 of FIG. 1 may perform overlap-add between each ‘LPD_SEQUENCE’ 2301, 2302, 2303, and 2304 and ‘STOP_{—}1024_SEQUENCE’ 2305 in a region 2306 corresponding to 256 points. When an LPD mode of a last sub-frame of ‘LPD_SEQUENCE’ 2304 is ‘0’, the LPD mode of the final sub-frame may be changed to ‘1’.

As illustrated in FIG. 23, each ‘LPD_SEQUENCE’ 2301, 2302, 2303, and 2304 and ‘STOP_{—}1024_SEQUENCE’ 2305 may be overlap-added based on a folding point. Also, a block size to process ‘STOP_{—}1024_SEQUENCE’ 2305 corresponding to a FD mode may be 2048 as opposed to 2304.

Referring to FIGS. 22 and 23, a block size of a window sequence of the FD mode may be changed to perform a 2048-MDCT transform. Here, the window sequence may be connected to ‘LPD_SEQUENCE’. Accordingly, as illustrated in FIG. 20, the window sequence of the FD mode may not be required to perform a 2034-MDCT transform. According to an embodiment of the present invention, although an LPD mode is changed to the FD mode, a window sequence having a size of 2304 such as ‘STOP_{—}1152_SEQUENCE’ and ‘STOP_START_WINDOW_{—}1152’, illustrated in FIG. 3, may not be required. Accordingly, since a window sequence having a different block size is not required when mode switching occurs, an encoding efficiency may be improved.

Thus, the window sequence processing method according to an embodiment of the present invention with respect to CASE 4 is as follows:

(1) a window sequence of a FD mode and a window sequence ‘LPD_SEQUENCE’ of an LPD mode may be overlap-added based on an MDCT folding point.

(2) a window sequence, connected to ‘LPD_SEQUENCE’, of a FD mode may be changed based on an LPD mode of a final window of ‘LPD_SEQUENCE’.

(3) a block size of the window sequence connected to ‘LPD_SEQUENCE’, that is, an MDCT transform size, may be 2048, and a block having a size of 2304 may not be required.

The USAC (decoding) according to an embodiment of the present invention may obtain an output signal where an aliasing is canceled by simply applying a window sequence, which is applied to the USAC (encoding), to overlap-add.

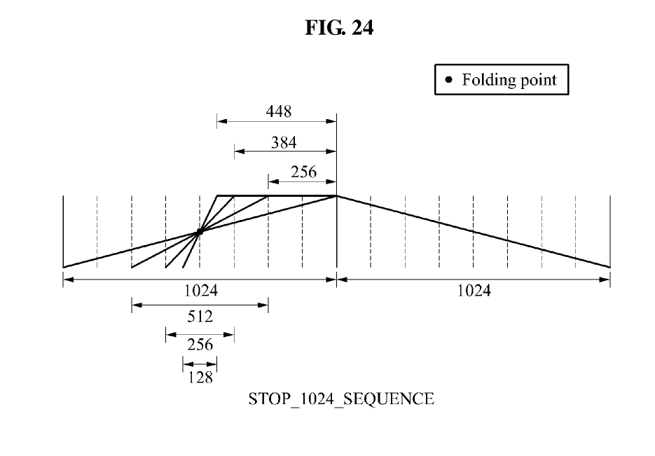

FIG. 24 is a diagram illustrating ‘STOP_{—}1024_SEQUENCE’ where the window sequence of FIG. 22 is applied according to an embodiment of the present invention.

Referring to FIG. 24, a left window of a window sequence of an AAC MODE of a previous frame may be changed to each line 2401, 2402, and 2403. A line 2404 may be associated with a window sequence 2205 of the AAC MODE.

According to an embodiment of the present invention, since an MDCT coefficient is 1024, the window sequence of FIG. 24 may be defined as ‘STOP_{—}1024_SEQUENCE’. Conversely, since a block size of the window sequence, defined in the RM of FIG. 3, is 2304, and an MDCT coefficient is 1152, the window sequence of FIG. 3 may be defined as ‘STOP_{—}1152_SEQUENCE’.

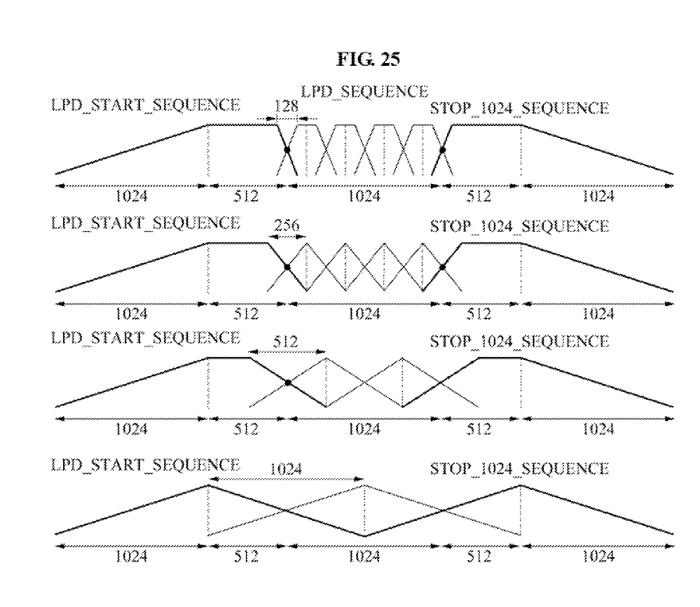

FIG. 25 is a diagram illustrating results where the window sequences of FIG. 16 and FIG. 24 are applied according to an embodiment of the present invention.

FIG. 25 illustrates ‘LPD_START_SEQUENCE’, ‘LPD_SEQUENCE’, and ‘STOP_{—}1024_SEQUENCE’. That is, the window sequences illustrated in FIG. 25 may be window sequences processed when the Mode switch-1 performs mode switching a FD mode→PD mode→FD mode.

Referring to FIG. 25, a shape of a right window of ‘LPD_START_SEQUENCE’ and a shape of a left window of ‘STOP_{—}1024_SEQUENCE’ may be changed based on ‘LPD_SEQUENCE’. Also, a size of a region which is overlap-added to each of ‘LPD_START_SEQUENCE’ and ‘STOP_{—}1024_SEQUENCE’ may be changed based on ‘LPD_SEQUENCE’.

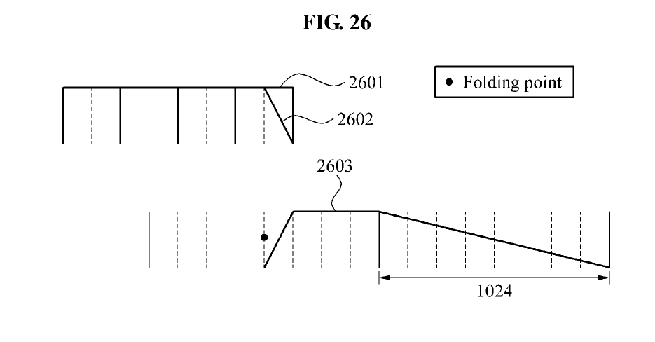

FIG. 26 is a diagram illustrating a window when an ACELP is changed to a FD according to an embodiment of the present invention.

When an LPD mode of ‘LPD_SEQUENCE’ corresponding to a previous frame is {x, x, x, 0}, that is, when an end sub-frame of the previous frame is an ACELP, a window of an end sub-frame of ‘LPD_SEQUENCE’ may be changed from a line 2601 to a line 2602. Subsequently, a window sequence of a current frame and ‘LPD_SEQUENCE’ corresponding to the previous frame, illustrated in FIG. 26, are overlap-added and cross-folded. Here, the window sequence where the LPD mode is {x, x, x, 0} may be processed by only USAC (decoding), since an ACELP signal is a time domain signal without TDA.

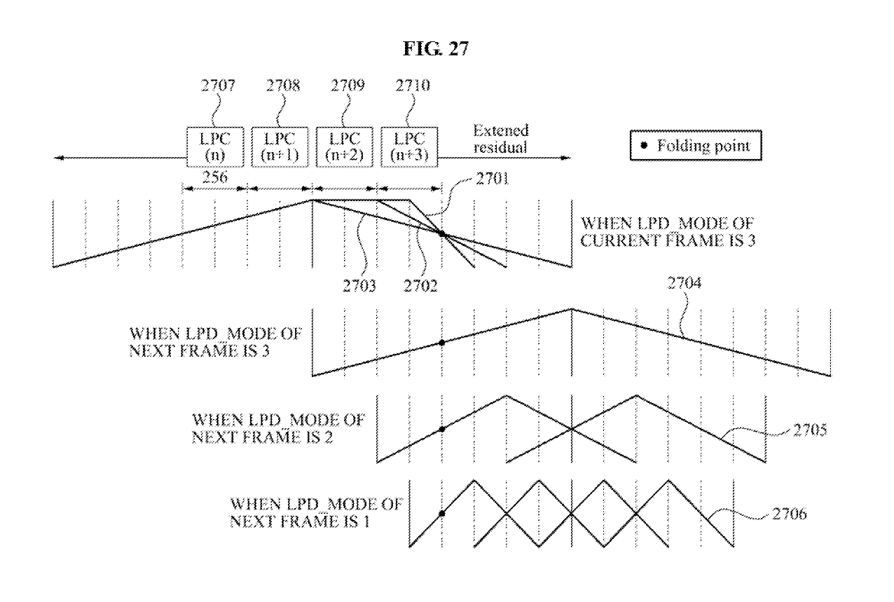

FIG. 27 is a diagram illustrating a window sequence and an LPC extraction location based on an LPD mode of a current frame and an LPD mode of a next frame according to an embodiment of the present invention.

A right window of ‘LPD_SEQUENCE’ of a current frame may be changed based on an LPD mode of ‘LPD_SEQUENCE’ 2702, 2703, and 2704 of a next frame. In FIG. 27, the LPD mode of ‘LPD_SEQUENCE’ of the current frame may be {3, 3, 3, 3}.

As illustrated in FIG. 27, when ‘LPD_SEQUENCE’ 2704 where an LPD mode of the next frame is {3, 3, 3, 3} is connected, a right window of ‘LPD_SEQUENCE’ of the current frame may be changed to the line 2703. Also, when ‘LPD_SEQUENCE’ 2705 where an LPD mode of the next frame is {2, 2, 2, 2} is connected, the right window of ‘LPD_SEQUENCE’ of the current frame may be changed to the line 2702. Also, when ‘LPD_SEQUENCE’ 2706 where an LPD mode of the next frame is {1, 1, 1, 1} is connected, the right window of ‘LPD_SEQUENCE’ of the current frame may be changed to a line 2701.

That is, when mode switching occurs from an LPD mode to another LPD mode, ‘LPD_SEQUENCE’ of the current frame may be changed based on an LPD mode of ‘LPD_SEQUENCE’ of the next frame. Accordingly, the changed ‘LPD_SEQUENCE’ in the current frame may be overlap-added to ‘LPD_SEQUENCE’ of the next frame.

In FIG. 27, an LPC may be extracted for each sub-frame of 256 points. According to an embodiment of the present invention, a folding point where window sequences are overlap-added may be located in a boundary of a sub-frame. The LPC may be extracted for each sub-frame of 256 points by setting the folding point as a starting point. An LPC extraction location with respect to ‘LPD_SEQUENCE’ of the current frame may correspond to each sub-frame 2707, 2708, 2709, and 2710. That is, the LPC may be extracted by matching with a boundary of a sub-frame based on the folding point as the starting point. LPC(n) 2707 and LPC(n+3) 2710 may extract the LPC in a residual region from among entire frames excluding the corresponding sub-frame.

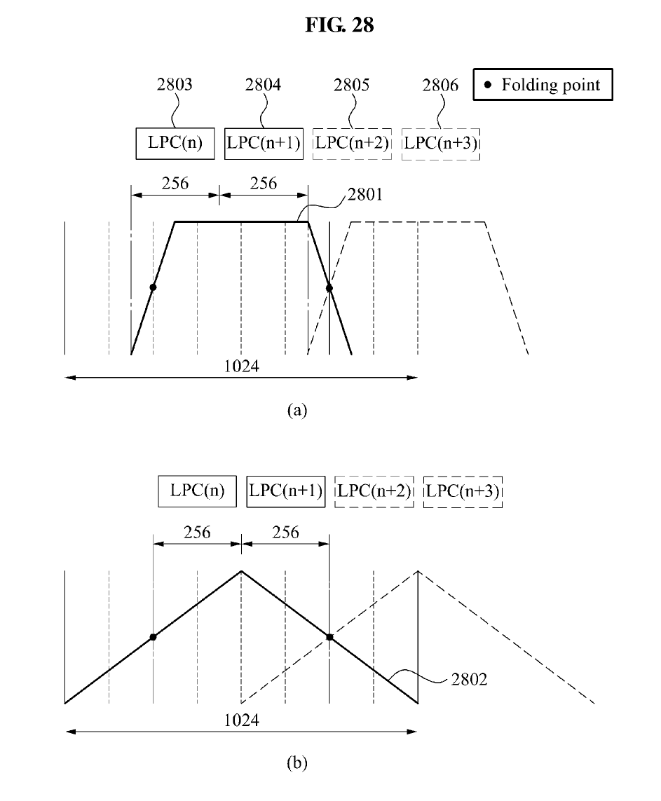

FIG. 28 is a diagram illustrating an LPC extraction location in a conventional art and an LPC extraction location according to an embodiment of the present invention.

FIG. 28 (a) illustrates the LPC extraction location in a conventional art, and FIG. 28 (b) illustrates the LPC extraction location according to an embodiment of the present invention. Referring to FIG. 28 (a), an LPC may be extracted in LPC extraction locations 2803, 2804, 2805, and 2806, which are spaced apart from a boundary of a sub-frame by 64 points, regardless of a folding point. Also, a size of a region where windows are overlap-added may be 128 points in FIG. 28 (a).

Referring to FIG. 28 (b), an LPC may be extracted in LPC extraction locations 2803, 2804, 2805, and 2806, corresponding to a sub-frame, based on a folding point as a starting point. Here, the folding point may be located in a boundary of the sub-frame. Also, a size of a region where windows are overlap-added may be 256 points in FIG. 28 (b). Accordingly, information about additional 64 points may not be required for LPC extraction.

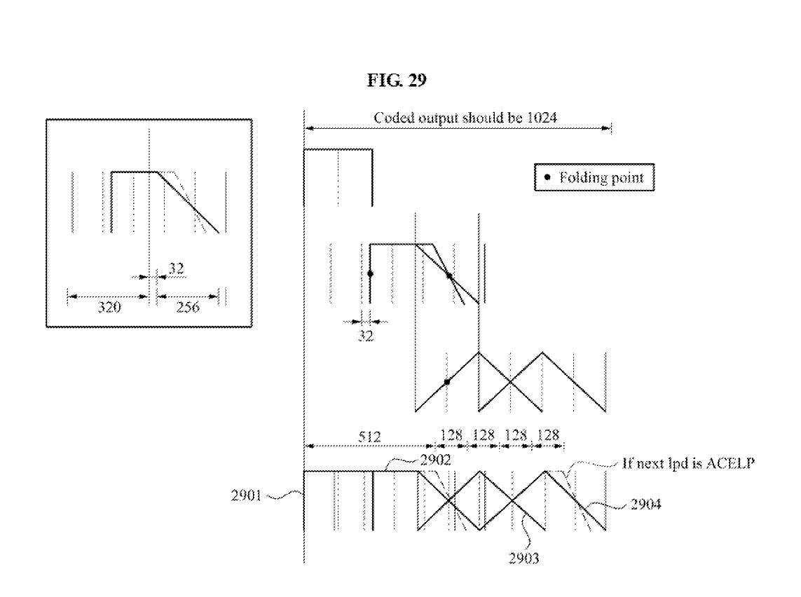

FIG. 29 is a diagram illustrating a window sequence when lpd_mode={1, 0, 1, 1} according to an embodiment of the present invention.

Referring to FIG. 29, when an ACELP mode is applied in a first sub-frame, a window 2901 corresponding to the first sub-frame and a window 2902 corresponding to a second sub-frame may not be overlapped. However, a right portion of the window 2902 may be determined based on an LPD mode of a window 2903 corresponding to a third sub-frame.

When an LPD mode of a window after a final sub-frame is an ACELP mode, that is, lpd_mode=0, the window defined in the RM of FIG. 3 may be applied as a window 2904. Conversely, when the LPD mode of the window after the final sub-frame is not the ACELP mode (lpd_mode=0), a right portion of the window 2904 may be changed to enable the right portion of the window 2904 to be overlapped by 256 points.

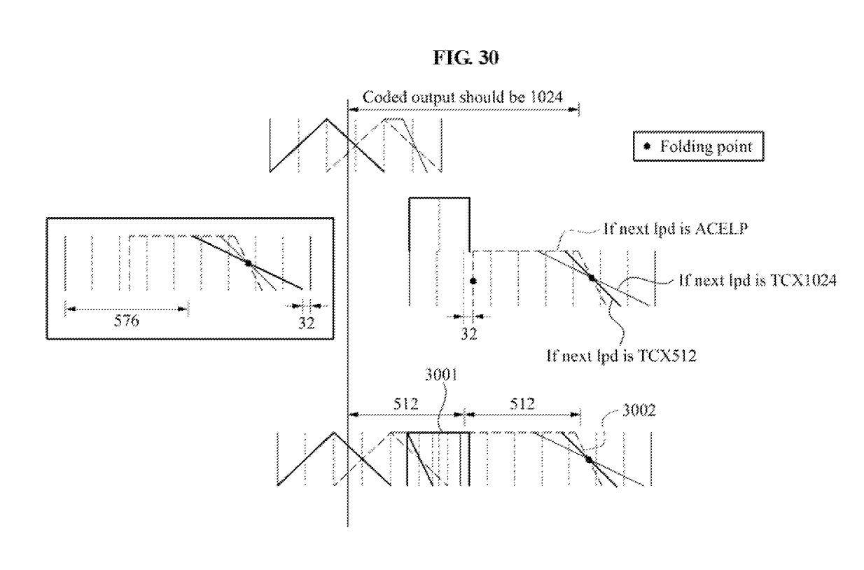

FIG. 30 is a diagram illustrating a window sequence when lpd_mode={1, 0, 2, 2} according to an embodiment of the present invention.

When an ACELP (lpd_mode=0) occurs in a previous sub-frame or a next sub-frame, a type of a connection portion of a window 3002, corresponding to a current sub-frame where lpd_mode=1, lpd_mode=2, or lpd_mode=3, may be the same as Table 1.

Additionally, when lpd_mode=0 (ACELP) in a window 3001 corresponding to the previous sub-frame, and lpd_mode=1, lpd_mode=2, or lpd_mode=3 in the next sub-frame, a right portion of the window 3002 corresponding to the current sub-frame may be changed based on an LPD mode of the next sub-frame. Also, a left portion of the window 3002 may be changed to a rectangular shape and may not overlap with the window 3001 corresponding to the previous sub-frame.

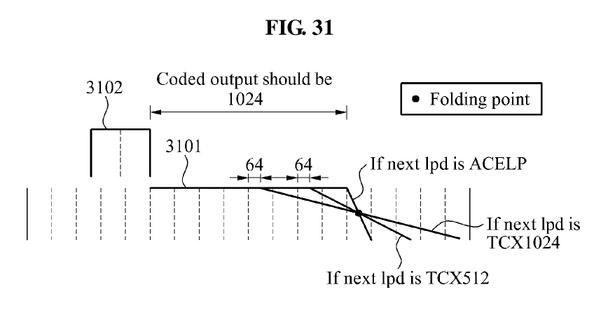

FIG. 31 is a diagram illustrating a window sequence when lpd_mode={3, 3, 3, 3} in a current frame, and lpd_mode={x, x, x, 0} in a previous frame according to an embodiment of the present invention.

Similarly to FIG. 29 and FIG. 30, FIG. 31 illustrates a window 3101 corresponding to the current frame, when lpd_mode=0 in a window 3102 corresponding to the previous frame. Here, lpd_mode={3, 3, 3, 3} in the window 3101 corresponding to the current frame. A right portion of the window 3101 may be changed to an LPD mode of a next frame. In FIG. 31, TCX 1024 may indicate lpd_mode=3 in a window corresponding to the next frame, and TCX 512 may indicate lpd_mode=2 in the window corresponding to the next frame. Also, ACELP may indicate lpd_mode=0 in the window corresponding to the next frame.

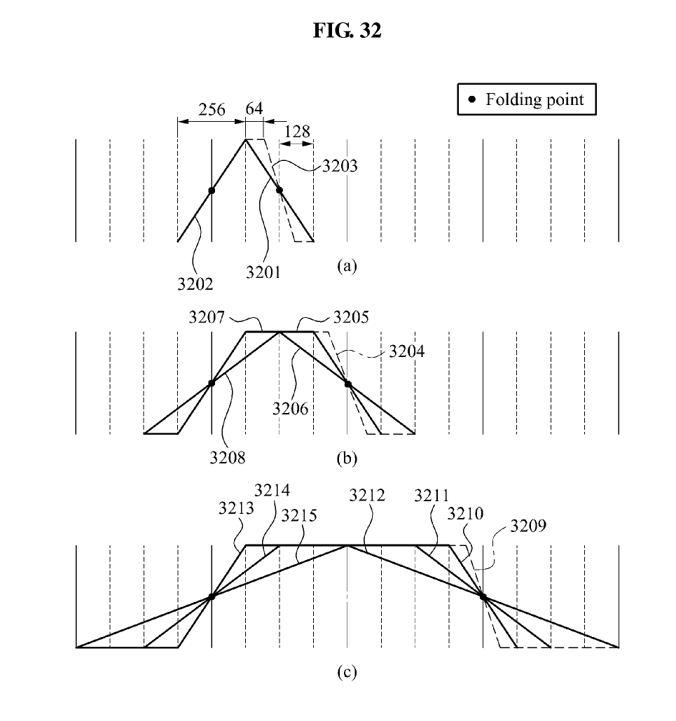

FIG. 32 is a diagram illustrating window sequences based on lpd_mode=0 (ACELP) of a previous sub-frame and a next sub-frame, (a) when lpd_mode=1 (TCX 256) (a), (b) when lpd_mode=2 (TCX 512), and (c) when lpd_mode=3 (TCX 1024).

Referring to FIG. 32 (a), when lpd_mode=1 (TCX 256) in a current frame and a window corresponding to the next frame is ACELP, a right portion of a window corresponding to the current frame may be a line 3203. When lpd_mode=1 in the previous frame and lpd_mode=1 in the window corresponding to the next frame, a left portion of the window corresponding to the current frame may be a line 3202, and a right portion of the window corresponding to the current frame may be a line 3201. However, when lpd_mode=0 (ACELP) in the previous frame, the window corresponding to the current frame may have a same shape as the window 2902 in FIG. 29.

In this instance, as illustrated in FIG. 29, when lpd_mode=1 in a next window, a right portion of the window 2902 may be represented in solid line. When lpd_mode=0 in the next window, the right portion of the window 2902 may be represented in dotted line.

Referring to FIG. 32 (b), when lpd_mode=2 (TCX 512) in a current frame and a window corresponding to the next frame is ACELP, a right portion of a window corresponding to the current frame may be a line 3204. When lpd_mode=1 in the previous frame, a left portion of the window corresponding to the current frame may be a line 3207. Also, when lpd_mode=1 in the next frame, a right portion of the window corresponding to the current frame may be a line 3205.

When lpd_mode=2 in the previous frame, the left portion of the window corresponding to the current frame may be a line 3208. Also, when lpd_mode=2 in the next frame, the right portion of the window corresponding to the current frame may be a line 3206.

However, when lpd_mode=0 (ACELP) in the previous frame, the window corresponding to the current frame may have a same shape as the window 3002 in FIG. 30. In this instance, as illustrated in FIG. 30, a right portion of the window 3002 may be changed based on an LPD mode of a next frame.

Also, when an LPD mode of the current frame is 1 or 2, and the LPD mode of the next frame is greater than the LPD mode of the current frame, a window corresponding to the current frame may be changed to match the LPD mode of the next frame.

For example, when the LPD mode of the current frame is 1 and the LPD mode of the next frame is 2, a right portion of the window corresponding to the current frame may be a line 3201 in FIG. 32. Also, when the LPD mode of the current frame is 2 and the LPD mode of the next frame is 3, a right portion of the window corresponding to the current frame may be the line 3204 in FIG. 32.

Referring to FIG. 32 (c), when lpd_mode=3 (TCX 1024) in a current frame and a window corresponding to the next frame is ACELP, a right portion of a window corresponding to the current frame may be a line 3209. When lpd_mode=1 in the previous frame, a left portion of the window corresponding to the current frame may be a line 3213. Also, when lpd_mode=1 in the next frame, a right portion of the window corresponding to the current frame may be a line 3210.

When lpd_mode=2 in the previous frame, the left portion of the window corresponding to the current frame may be a line 3214. Also, when lpd_mode=2 in the next frame, the right portion of the window corresponding to the current frame may be a line 3211.

When lpd_mode=3 in the previous frame, the left portion of the window corresponding to the current frame may be a line 3215. Also, when lpd_mode=3 in the next frame, the right portion of the window corresponding to the current frame may be a line 3212.

However, when lpd_mode=0 (ACELP) in the previous frame, the window corresponding to the current frame may have a same shape as the window 3101 in FIG. 31. In this instance, as illustrated in FIG. 31, a right portion of the window 3101 may be changed based on an LPD mode of a next frame.

Accordingly, in the window corresponding to the current frame in FIG. 32, a left portion of the window may be changed based on an LPD mode of the previous frame, and a right portion may be changed based on an LPD mode of the next frame.

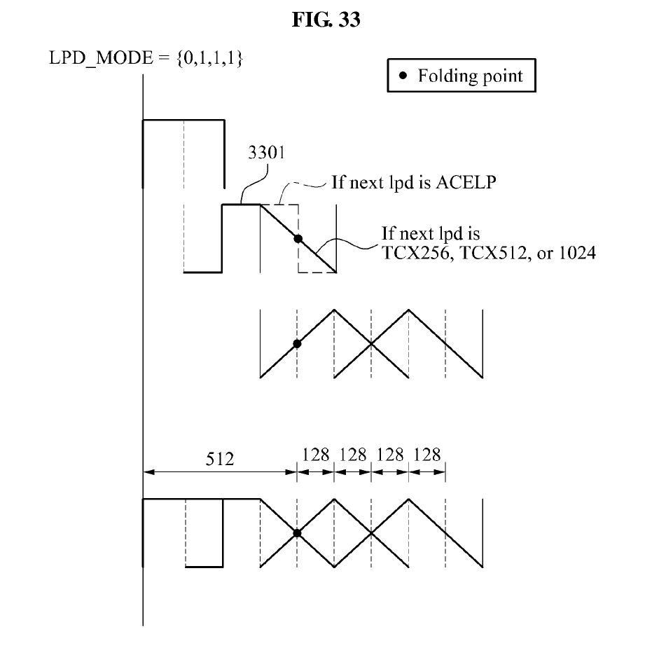

FIG. 33 is a diagram illustrating a window sequence when an LPD mode of a current sub-frame is 1 (TCX 256) and an LPD mode of a previous sub-frame is 0 according to an embodiment of the present invention.

Referring to FIG. 33, although a previous frame and a next frame of a current frame is an ACELP mode, only shape of a window of the current frame may change. For example, when lpd_mode=1 (TCX 256) in the current frame, and the previous frame is in the ACELP mode, a left portion of a window 3301 corresponding to the current frame may be a rectangular shape, and a right portion of the window 3301 may be changed based on an LPD mode (TCX 256, TCX 512, and TCX 1024) of the next frame.

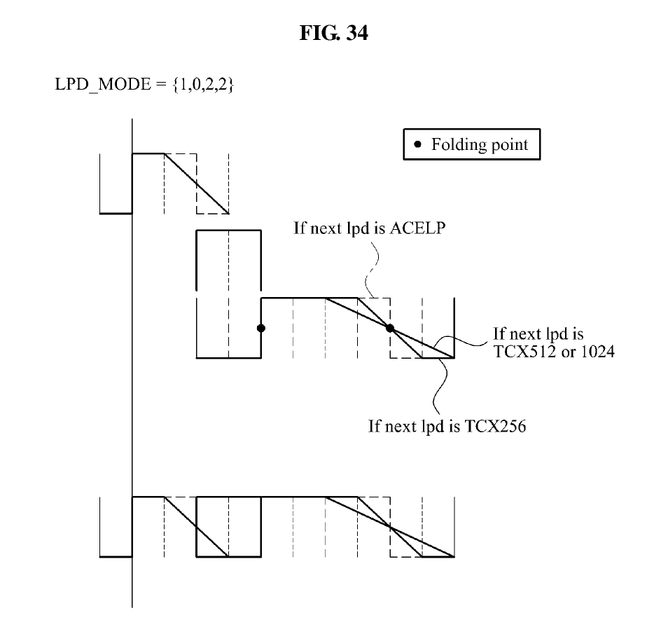

FIG. 34 is a diagram illustrating a window sequence when an LPD mode of a current sub-frame is 2 (TCX 512) and an LPD mode of a previous sub-frame is 0 according to an embodiment of the present invention.

Referring to FIG. 34, although a previous frame and a next frame of a current frame is an ACELP mode, only shape of a window of the current frame may change. For example, when lpd_mode=2 (TCX 512) in the current frame, and the previous frame is in the ACELP mode, a left portion of a window 3401 corresponding to the current frame may be a rectangular shape, and a right portion of the window 3401 may be changed based on an LPD mode (TCX 512 and TCX 1024) of the next frame.

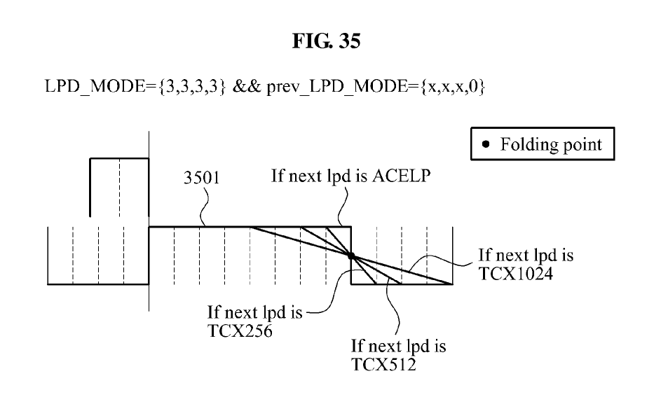

FIG. 35 is a diagram illustrating a window sequence when an LPD mode of a current sub-frame is 3 (TCX 1024) and an LPD mode of a previous sub-frame is 0 according to an embodiment of the present invention.

Referring to FIG. 35, although a previous frame and a next frame of a current frame is an ACELP mode, only shape of a window of the current frame may change. For example, when lpd_mode=3 (TCX 1024) in the current frame, and the previous frame is in the ACELP mode, a left portion of a window 3501 corresponding to the current frame may be a rectangular shape, and a right portion of the window 3501 may be changed based on an LPD mode (TCX 256, TCX 512, and TCX 1024) of the next frame.

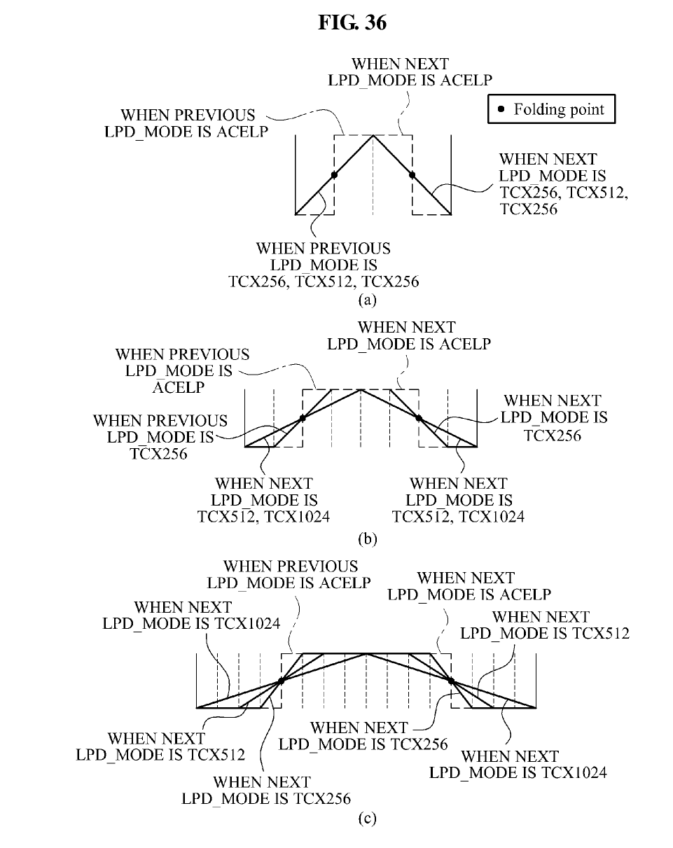

FIG. 36 is a diagram illustrating results where the window sequences of FIGS. 33 through 35 are combined.

FIG. 36 (a) may be associated with when an LPD mode of the current frame is 1. FIG. 36 (b) may be associated with when an LPD mode of the current frame is 2. FIG. 36 (c) may be associated with when an LPD mode of the current frame is 3. In this instance, FIG. 36 may be associated with when a left portion of a window corresponding to the current frame is determined based on an LPD mode of a previous frame, and when a right portion of the window corresponding to the current frame is determined based on an LPD mode of a next frame.

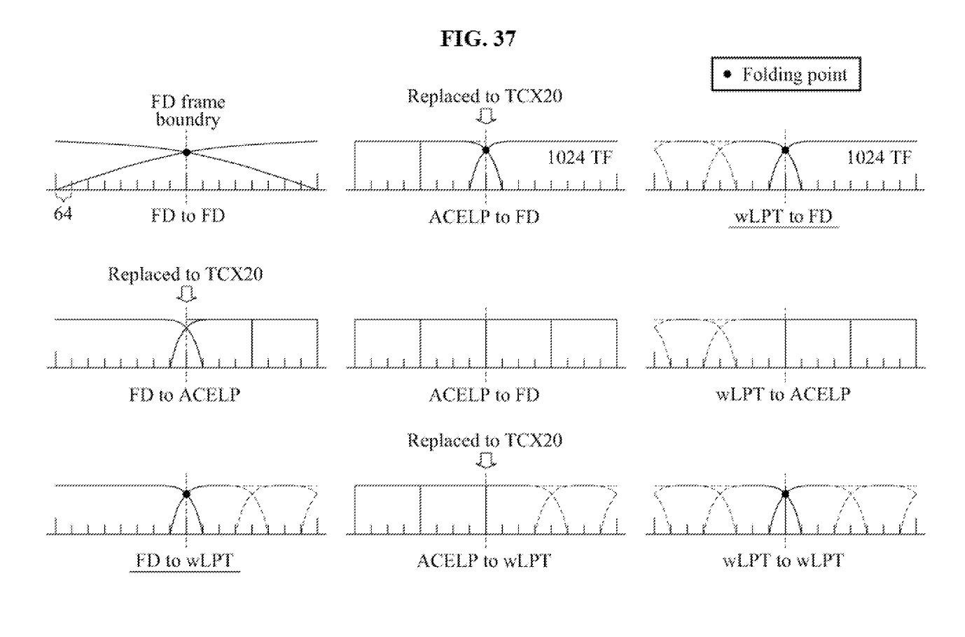

FIG. 37 is a diagram illustrating a window sequence when mode switching occurs according to an embodiment of the present invention.

The Mode switch-1 of FIG. 1 may perform mode switching between FD modes, from an LPD mode to a FD mode, and from a FD mode to an LPD mode, based on a frame of an input signal. The Mode switch-2 may perform mode switching between LPD modes based on a sub-frame of an input signal. In this instance, when an LPD mode is ‘0’, the LPD mode may be an ACELP. When the LPD mode is not ‘0’, the LPD mode may be a wLPT or TCX.

FIG. 37 illustrates a window sequence processed by the Blockswitching-1 and the Blockswitching-2 when mode switching occurs in the Mode switch-1 and the Mode switch-2. Referring to FIG. 37, a folding point may be located in a boundary of a sub-frame and a size of the frame may be 1024. An size of 128 points in a region where windows are overlapped is illustrated in FIG. 37 for a simple description of the present invention.

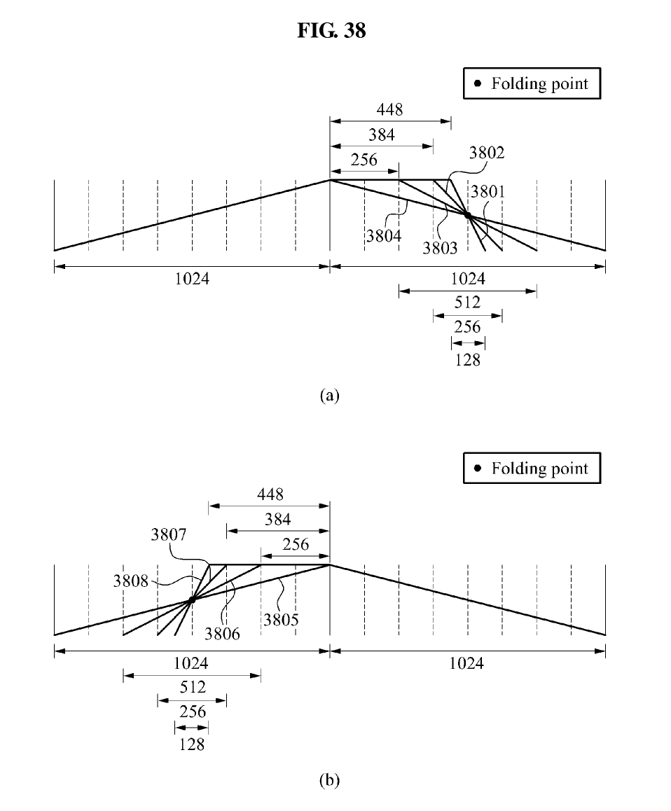

FIG. 38 is a diagram illustrating a result of change of ‘LPD_START_SEQUENCE’ and ‘STOP_{—}1152_SEQUENCE’ of FIG. 3 according to an embodiment of the present invention.

FIG. 38 (a) illustrates the change of ‘LPD_START_SEQUENCE’ of FIG. 3, and a size of MDCT may be 1024. ‘LPD_START_SEQUENCE’ of FIG. 38 (a) may be identical to FIG. 16, and a right portion of ‘LPD_START_SEQUENCE’ may be changed to each line 3802, 3803, and 3804 based on an LPD mode of ‘LPD_SEQUENCE’ of a next frame. A line 3801 may indicate that an interval of a region, overlapping with ‘LPD_SEQUENCE’, is 128 points, which is identical to a window sequence associated with ‘FD to wLPT (or TCX)’ of FIG. 37.

FIG. 38 (b) illustrates the change of ‘STOP_{—}1024_SEQUENCE’ of FIG. 3, and a size of MDCT may be 1024. Here, since the size of MDCT is 1152 in FIG. 3, a window sequence has been defined as ‘STOP_{—}1152_SEQUENCE’. ‘STOP_{—}1024_SEQUENCE’ of FIG. 38 (b) may be identical to FIG. 24, and a right portion of ‘LPD_START_SEQUENCE’ may be changed to each line 3805, 3806, and 3807 based on an LPD mode of ‘LPD_SEQUENCE’ of a next frame. A line 3808 may indicate that an interval of a region, overlapping with ‘LPD_SEQUENCE’, is 128 points, which is identical to a window sequence associated with ‘wLPT (or TCX) or FD’ of FIG. 37.

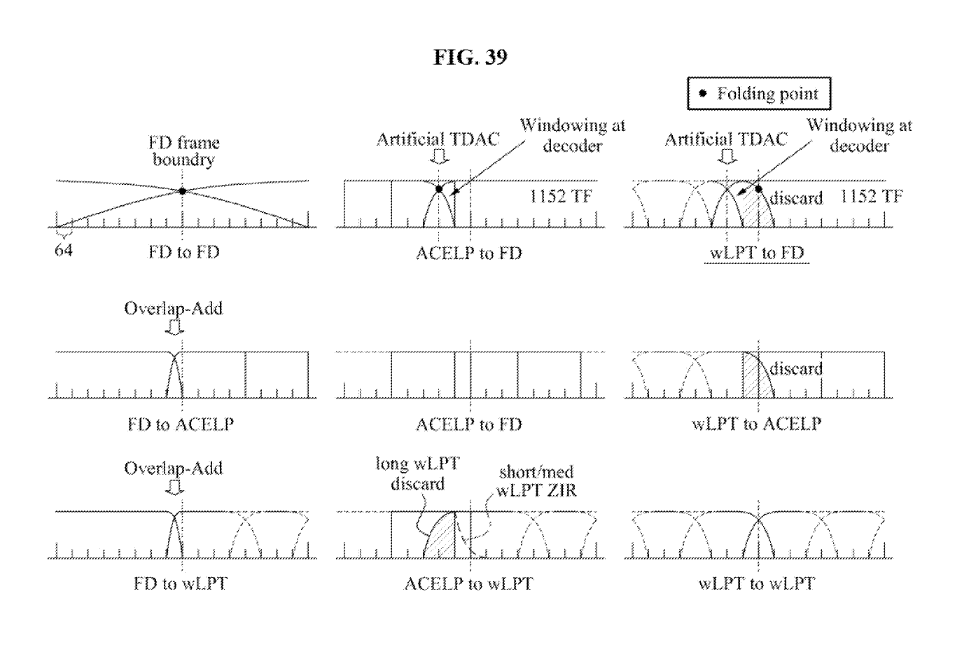

FIG. 39 is a diagram illustrating a window sequence when mode switching occurs in a conventional art.

When mode switching occurs from a FD mode to an LPD mode, a time domain corresponding to 64 points may be overlap-added, and thus a frame alignment may be unsuitable in comparison with FIG. 37. Additionally, when converting wLPC (TCX) to FD, a window size of FD mode may be 2304 (a coding coefficient is 1152). Accordingly, it may be ascertained that a coding efficiency may be reduced by 64 points in comparison with a window size of 2048 (a coding coefficient is 1024) according to an embodiment of the present invention.

Hereinafter, a method of adjusting a length of an overlap area of a window when a transition is generated based on a window sequence to improve a coding efficiency will be described in detail. In particular, in the present invention, an MDCT-based USAC may increase an encoding efficiency by adjusting an overlap area between window sequences applied when a mode of an input signal is changed, and simultaneously may prevent generation of noise by dynamically adjusting a length of an overlap area of a window when a transition is generated in the overlap area.

In particular, a problem may occur when the USAC encodes signals by two stages. Specifically, the USAC may encode signals through two stages, namely, an ‘intra-frame analysis’ stage, and a ‘frames after windowing’ stage.

First, in the ‘intra-frame analysis’ stage, the USAC may divide a super frame into sub-frames with appropriate lengths, in order to maximize an encoding gain. In the ‘frames after windowing’ stage, the USAC may apply a predefined window sequence for each of the sub-frames.

A transition may be generated during an extremely short time period, due to a change in properties of each frame in a sound signal. Generally, an encoding gain may be increased when a super frame is divided into relatively long sub-frames. However, in the ‘frames after windowing’ stage, when windows are overlapped between the sub-frames, a noise such as a pre-echo may occur due to the transition. Accordingly, when a transition is generated in a boundary of a sub-frame, the USAC may divide the super frame into relatively short sub-frames in the ‘intra-frame analysis’ stage.

The window sequence described in the present invention may utilize a converting technique between long frames and short frames in an Advanced Audio Coding (AAC)-based audio encoding scheme. Additionally, an LPC mode suitable for audio encoding may include both a case in which a single super frame is used as a single frame (TCX 80, lpd_mode=3), and a case in which a single super frame is divided into four short sub-frames (TCX 20, lpd_mode=1 or ACELP), thereby efficiently dealing with the transition.

The window sequence described in the present invention may deal with the transition. However, when a window with a long overlap area is applied to increase the encoding efficiency, an encoding gain in the transition may be reduced, and a noise problem in the transition may also exist. Accordingly, the present invention may provide a method of effectively dealing with a transition by a USAC according to the present invention, even when a window with a long overlap area is applied to increase the encoding efficiency.

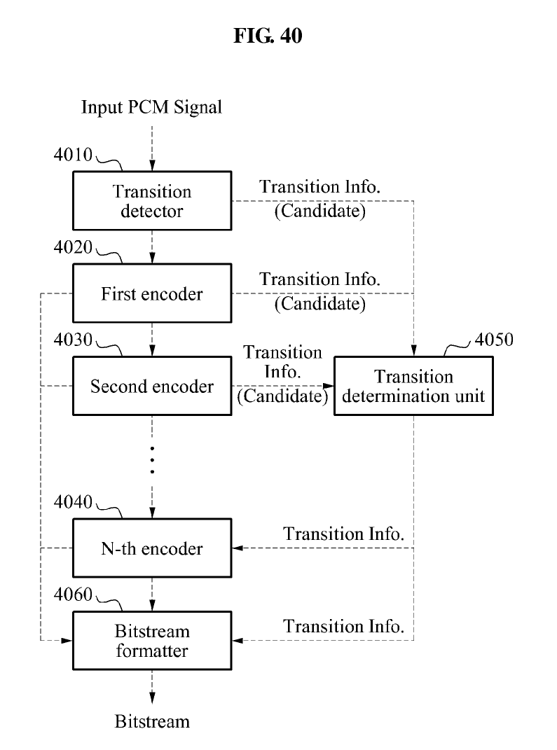

FIG. 40 is a diagram illustrating an overall configuration of a USAC for generating a bitstream including a transition according to an embodiment of the present invention.

Referring to FIG. 40, the USAC may include a transition detector 4010, a first encoder 4020, a second encoder 4030, an N-th encoder 4040, a transition determination unit 4050, and a bitstream formatter 4060.

The transition detector 4010 may detect a transition from an input signal, namely an input PCM signal. For example, the transition detector 4010 may detect a transition in a location adjacent to a boundary of a super frame including at least one sub-frame among a plurality of sub-frames in the input signal.

The first encoder 4020 and the second encoder 4030 may encode the input signal using specific encoding schemes, respectively, and may detect a transition from a result of the encoding. For example, the first encoder 4020 and the second encoder 4030 may encode the input signal using either a Spectral Bandwidth Extension (SBE) encoding scheme or a Parametric Stereo (PS) encoding scheme.

The SBE encoding scheme may be an encoding scheme based on human's auditory characteristics that a resolution in a High Frequency (HF) band is relatively low than in a resolution in a Low Frequency (LF) band. Specifically, in the SBE encoding scheme, a wide band audio input signal may be analyzed through a Quadrature Minor Filter (QMF) analysis, so that a control parameter representing a high band signal using an envelope, and an audio signal limited in a low band may be generated. Accordingly, the audio signal limited in the low band may be encoded through a core encoding of AAC, and an audio signal corresponding to the high band may be represented as additional data for SBE and may be transferred to a decoding apparatus. Subsequently, the decoding apparatus may generate a spectrum of an audio signal in the low band that is a core band, and may then generate an audio signal in the high band using envelope information, so that a wide band audio signal may be restored.

Additionally, the PS encoding scheme refers to a technology of representing, as a parameter, information regarding a relationship between channels of an input signal, and of generating a virtual stereo channel in a down-mixed mono signal. The PS encoding scheme may analyze a stereo input signal, may extract a parameter for controlling a stereo audio, and may transfer the extracted parameter together with the down-mixed mono signal to the decoding apparatus. Here, the used parameter may include, for example, an Inter-Channel Intensity Difference (IID), an Inter-channel Cross Correlation (ICC), an Inter-channel Phase Difference (IPD), an Overall Phase Difference (OPD), and the like.

Subsequently, the transition determination unit 4050 may finally determine a transition having a great influence among transitions detected by the transition detector 4010, the first encoder 4020, and the second encoder 4030. In other words, since a noise, namely a pre-echo, is generated due to the transition, the transition determination unit 4050 may finally determine the transition based on a degree of noise generated by the transition.

The N-th encoder 4040 may perform core-encoding on the input signal by adjusting a length of an overlap area of a window based on the transition determined by the transition determination unit 4050. For example, the N-th encoder 4040 may perform core-encoding by applying a window having an overlap area of which a length is reduced by the transition based on a folding point. Specifically, the N-th encoder 4040 may perform core-encoding on the input signal by applying a window to a current sub-frame to be encoded. Here, the applied window may be changed based on an LPD mode of a previous sub-frame, and an LPD mode of a next sub-frame.

Subsequently, the bitstream formatter 4060 may generate a bitstream that includes the final transition extracted from the results of the encoding performed by the first encoder 4020, and the second encoder 4030 through the N-th encoder 4040, and determined by the transition determination unit 4050. In other words, a USAC according to an embodiment of the present invention may include a transition in a bitstream for a decoding operation.

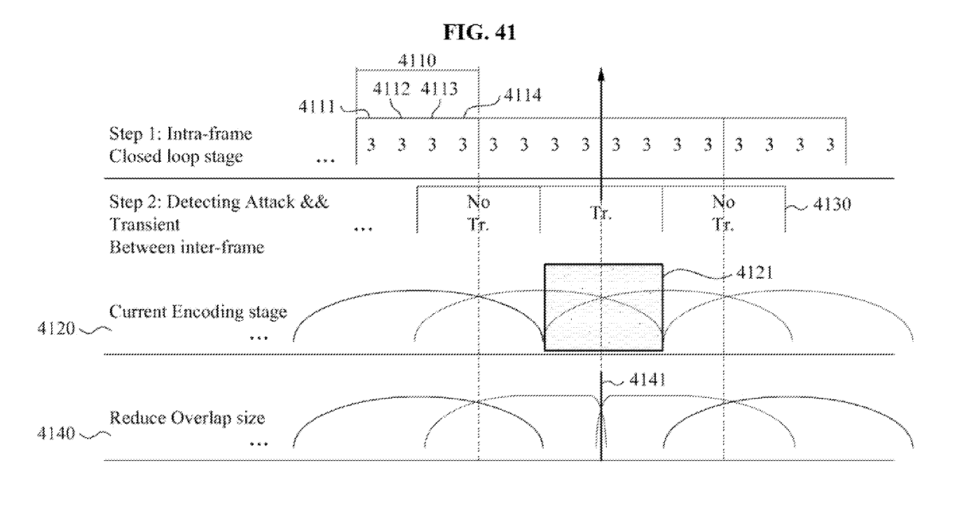

FIG. 41 is a diagram illustrating a process of adjusting an overlap area of a window when a transition is generated in a boundary of a frame corresponding to a TCX 80 according to an embodiment of the present invention.

Here, FIG. 41 illustrates a process of adjusting an overlap area of a window when four consecutive super frames are determined to be a TCX 80 (lpd_mode=3).

A super frame 4110 corresponding to a single LPD mode may be divided into four sub-frames 4111, 4112, 4113, and 4114, depending on a characteristic of a signal. Specifically, in a closed-loop stage with respect to the LPD mode, a scheme of dividing a super frame during an actual encoding operation, by calculating encoding gains for each result of dividing the super frame into sub-frames may be determined. Here, when a transition is generated within the super frame, the USAC may divide the super frame into relatively short sub-frames in the closed-loop stage, thereby efficiently performing encoding based on the transition.

Conversely, when a transition 4130 is generated between super frames, the transition 4130 may not be detected in the closed-loop stage in the LPD mode. Here, when an overlap area 4121 of a window applied between super frames during encoding is relatively long, a noise spreading over a wide area may be generated as shown in a current encoding stage 4120 of FIG. 41.

Accordingly, the USAC may perform an algorithm of detecting a transition prior to windowing and overlapping, for example a Reduce Overlap Size 4140, and may detect the transition 4130 between super frames. Additionally, the USAC may derive an overlap area 4141 by adjusting a length of an overlap area 4121 of a window based on the transition 4130. Subsequently, the USAC may perform encoding by applying the window with the overlap area 4141, so that an encoding efficiency may be increased using a relatively long window, and simultaneously so that unnecessary noise may be reduced by applying the overlap area 4141 corresponding to the transition 4130.

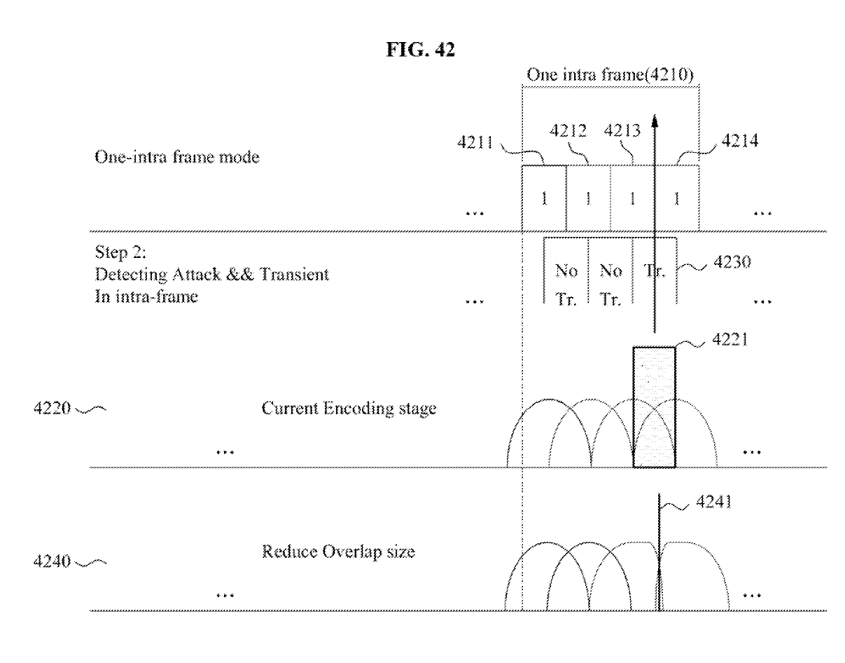

FIG. 42 is a diagram illustrating a process of adjusting an overlap area of a window when a transition is generated in a boundary of a frame corresponding to a TCX 20 according to an embodiment of the present invention.

Specifically, FIG. 42 illustrates a process of adjusting an overlap area 4221 of a window based on a transition 4230, when a single super frame 4210 is divided into four sub-frames 4211, 4212, 4213, and 4214 corresponding to four TCX 20 (lpd_mode=1).

In FIG. 42, it is assumed that a transition 4230 is generated between a third sub-frame 4213 and a fourth sub-frame 4214 among the four sub-frames. Here, a USAC may perform a Reduce Overlap Size 4240, may adjust a length of the overlap area 4221 of the window in a current encoding stage 4220 based on the transition 4230, and may derive an overlap area 4241. Subsequently, the USAC may perform encoding by applying a window having the overlap area 4241.

As a result, FIG. 41 illustrates a process of adjusting a length of an overlap area of a window when a transition is generated between super frames, and FIG. 42 illustrates a process of adjusting a length of an overlap area of a window when a transition is generated between sub-frames forming a super frame.

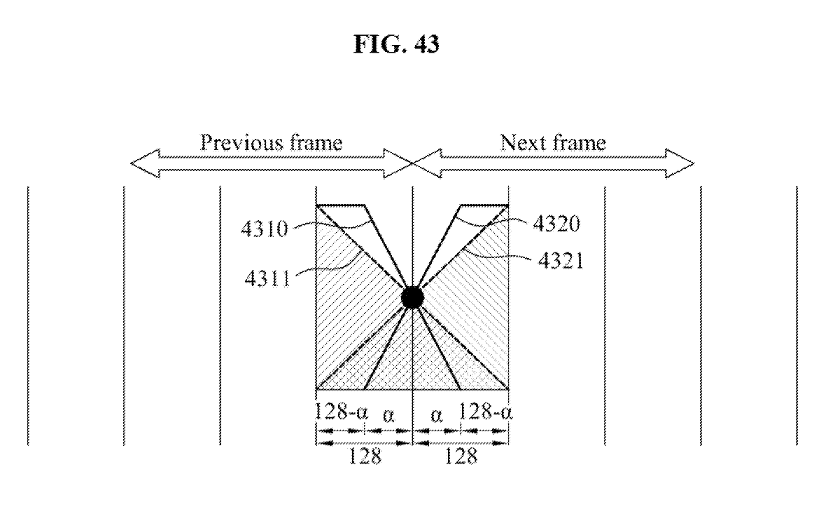

FIG. 43 is a diagram illustrating a process of adjusting a length of an overlap area of a window based on a transition when the overlap area has a length of 256, according to an embodiment of the present invention.

FIGS. 43 through 45 illustrate a process of adjusting a length of an overlap area of a window based on a transition when the overlap area has a long length.

Referring to FIG. 43, an overlap area of a window had a 256 sample length, however, the length of the overlap area is reduced to 2α due to generation of a transition. Here, the overlap area of the window may be disposed symmetrically based on a folding point that is located between frames. Accordingly, the length of the overlap area of the window may be symmetrically reduced by α based on the folding point, depending on the transition. While a of FIG. 43 is a 64 sample, a value of α may vary depending on a characteristic of a signal.

When a transition is not generated, the USAC may perform encoding by overlapping a window 4310 applied to a previous frame and a window 4320 applied to a next frame based on the folding point. Here, an overlap area between the windows 4310 and 4320 may have a 256 sample length. However, when a transition is generated, the USAC may perform encoding by overlapping a window 4311 applied to a previous frame and a window 4321 applied to a next frame based on the folding point. Here, an overlap area between the windows 4311 and 4321 may have a 2α sample length.

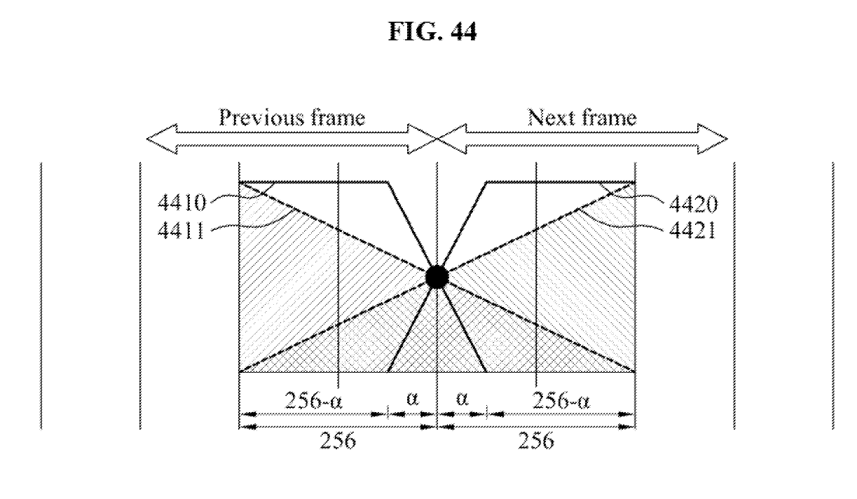

FIG. 44 is a diagram illustrating a process of adjusting a length of an overlap area of a window based on a transition when the overlap area has a length of 512, according to an embodiment of the present invention.

Referring to FIG. 44, an overlap area of a window had a 512 sample length, however, the length of the overlap area is reduced to 2α due to generation of a transition. Here, the overlap area of the window may be disposed symmetrically based on a folding point that is located between frames. Accordingly, the length of the overlap area of the window may be symmetrically reduced by a based on the folding point, depending on the transition. While a of FIG. 44 is a 64 sample, a value of α may vary depending on a characteristic of a signal.

When a transition is not generated, the USAC may perform encoding by overlapping a window 4410 applied to a previous frame and a window 4420 applied to a next frame based on the folding point. Here, an overlap area between the windows 4410 and 4420 may have a 512 sample length. However, when a transition is generated, the USAC may perform encoding by overlapping a window 4411 applied to a previous frame and a window 4421 applied to a next frame based on the folding point. Here, an overlap area between the windows 4411 and 4421 may have a 2α sample length.

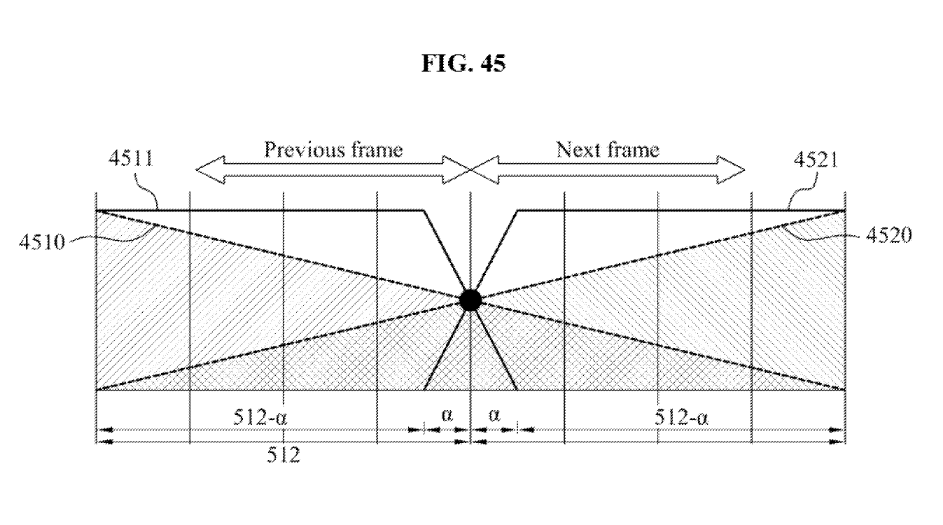

FIG. 45 is a diagram illustrating a process of adjusting a length of an overlap area of a window based on a transition when the overlap area has a length of 1024, according to an embodiment of the present invention.

An overlap area of a window had a 1024 sample length, however, the length of the overlap area is reduced to 2α due to generation of a transition between frames. Here, the overlap area of the window may be disposed symmetrically based on a folding point that is located between frames. Accordingly, the length of the overlap area of the window may be symmetrically reduced by a based on the folding point, depending on the transition. While α of FIG. 45 is a 64 sample, a value of α may vary depending on a characteristic of a signal.

When a transition is not generated, the USAC may perform encoding by overlapping a window 4510 applied to a previous frame and a window 4520 applied to a next frame based on the folding point. Here, an overlap area between the windows 4510 and 4520 may have a 1024 sample length. However, when a transition is generated, the USAC may perform encoding by overlapping a window 4511 applied to a previous frame and a window 4521 applied to a next frame based on the folding point. Here, an overlap area between the windows 4511 and 4521 may have a 2α sample length.

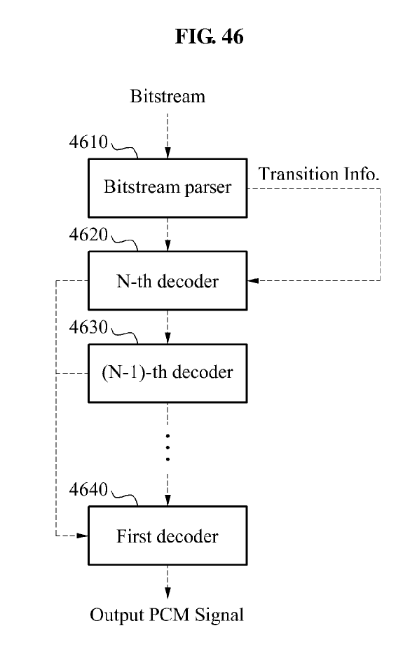

FIG. 46 is a diagram illustrating an overall configuration of a USAC that uses a bitstream including a transition, according to an embodiment of the present invention.

Referring to FIG. 46, a bitstream parser 4610 may parse a bitstream transmitted from the USAC of FIG. 40, and may extract a transition. Subsequently, an N-th decoder 4620, an (N−1)-th decoder 4630, or a first decoder 4640 may decode an input signal using the transition extracted from the bitstream parser 4610. In FIG. 46, a decoding scheme performed by each of the N-th decoder 4620, the (N−1)-th decoder 4630, or the first decoder 4640 may not be specified. For example, the first decoder 4640 may perform core-decoding on the input signal by adjusting a length of an overlap area of a window based on a transition. In this example, when the core-decoding performed by the first decoder 4640 may enable windows between frames to be overlapped, the length of the overlap area of the window may be adjusted. In a decoding mode where windows are not overlapped, there is no need to adjust the length of the overlap area of the window. Additionally, when the N-th decoder 4620 and the (N−1)-th decoder 4630 respectively performs either a SBE decoding or a PS decoding, there is no need to adjust the length of the overlap area of the window.

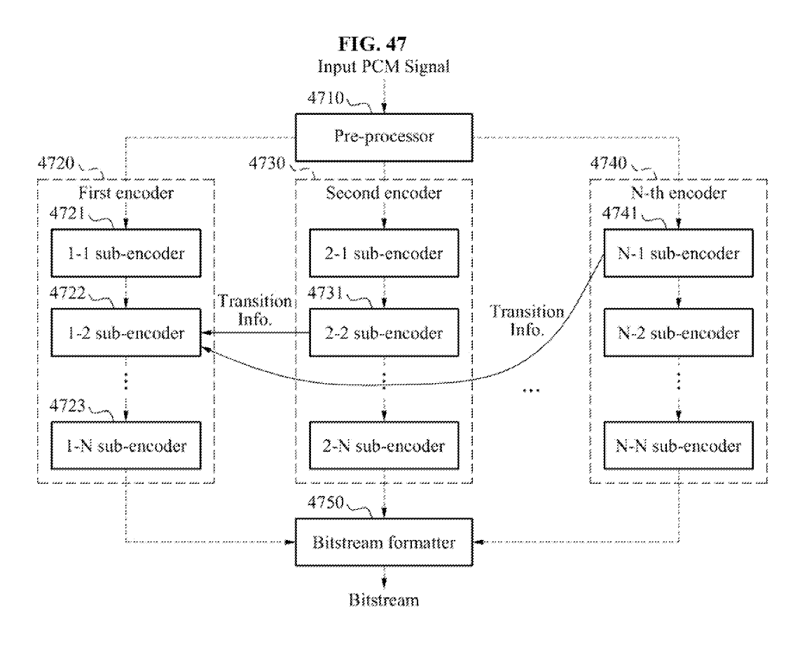

FIG. 47 is a diagram illustrating an overall configuration of a USAC that utilizes a transition extracted from an encoding result according to another embodiment of the present invention.

Specifically, FIG. 47 illustrates an example where a transition is not included in a bitstream. As a result, since the USAC of FIG. 47 does not need to include additional information regarding the transition in the bitstream, a compression rate may be improved.

A pre-processor 4710 may pre-process an input signal. Here, the pre-processor 4710 may perform pre-processing to divide a super frame into a plurality of sub-frames.

A first encoder 4720 may include a 1-1 sub-encoder 4721, a 1-2 sub-encoder 4722, and a 1-N sub-encoder 4723. Here, the 1-2 sub-encoder 4722 may encode the input signal using a transition that is extracted from a result of an encoding performed by a 2-2 sub-encoder 4731 of a second encoder 4730. Additionally, the 1-2 sub-encoder 4722 may encode the input signal using a transition that is extracted from a result of an encoding performed by an N−1 sub-encoder 4741 of an N-th encoder 4740.

In other words, the USAC of FIG. 47 may utilize transitions that are respectively extracted from independently operating encoders, and thus there is no need to include the transition in the bitstream. That is, a bitstream formatter 4750 may enable the encoded input signal to be included in the bitstream, and enable the transition not to be included in the bitstream and thus, it is possible to improve a compression rate with respect to the bitstream.

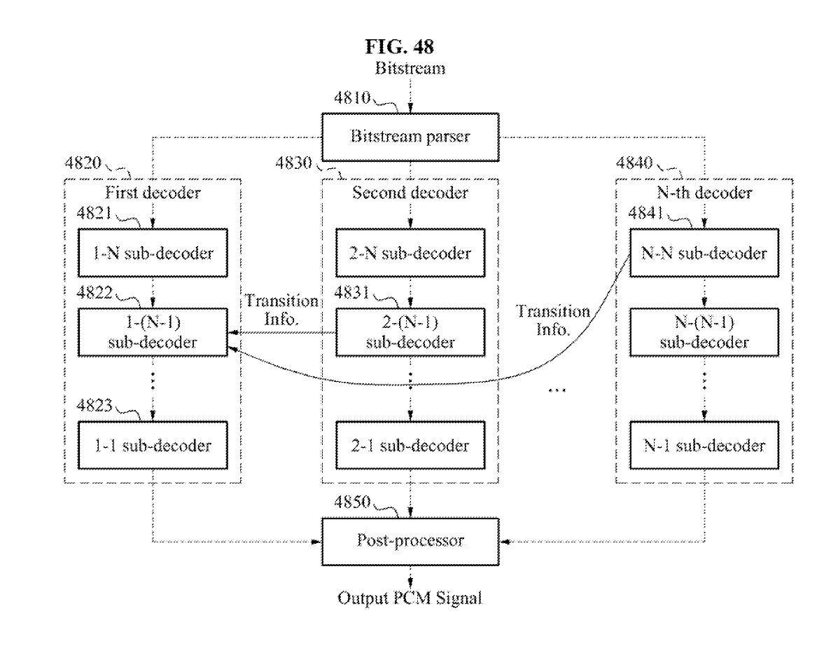

FIG. 48 is a diagram illustrating an overall configuration of a USAC that utilizes a transition extracted from a decoding result according to another embodiment of the present invention.

A bitstream parser 4810 of FIG. 48 may parse a bitstream transmitted from a USAC. A first decoder 4820 may include a 1-1 sub-decoder 4821, a 1-2 sub-decoder 4822, and a 1-N sub-decoder 4823. Here, the 1-2 sub-decoder 4822 may decode an input signal using a transition that is extracted from a result of a decoding performed by a 2-2 sub-decoder 4831 of a second decoder 4830. Additionally, the 1-2 sub-decoder 4822 may decode the input signal using a transition that is extracted from a result of a decoding performed by an N−1 sub-decoder 4841 of an N-th decoder 4840.

In other words, the USAC of FIG. 48 may utilize transitions that are respectively extracted between independently operating decoders, even when the transitions are not included in the bitstream.

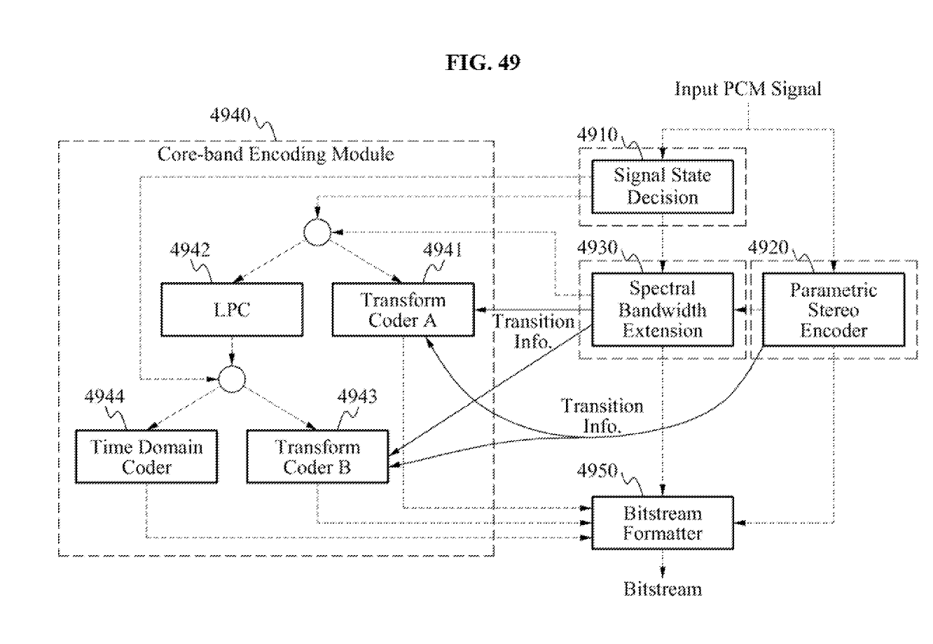

FIG. 49 is a diagram illustrating an actual applicable example of FIG. 47.

FIG. 49 illustrates an actual configuration of a USAC. A signal state decision unit 4910 may decide a state of an input signal. Specifically, the signal state decision unit 4910 may determine whether the input signal is similar to an audio signal or a speech signal.

In a core-encoder 4940, encoding may be performed selectively by either an LPC-based encoder 4942 or an MDCT-based encoder 4941, depending on the state of the input signal. For example, the encoder 4941 may encode an input signal similar to an audio signal, based on an MDCT-based AAC scheme. Additionally, the LPC-based encoder 4942 may enable either a time domain encoder 4944 or a frequency domain encoder 4943 to selectively encode an input signal similar to a speech. For example, the time domain encoder 4944 may encode the input signal based on an ACELP, and the frequency domain encoder 4943 may encode the input signal based on an MDCT-based TCX.

Additionally, an SBE-based encoder 4930 may perform encoding by generating a control parameter representing an HF band signal using an envelope, and an audio signal limited in a LF band. A PS-based encoder 4920 may perform encoding by representing, as a parameter, information regarding a relationship between channels of the input signal, and by generating a virtual stereo channel in a down-mixed mono signal.

Here, the encoder 4941 that performs MDCT-based encoding, and the encoder 4943 may perform encoding using a transition detected from the encoding result obtained by each of the encoders 4930 and 4920. To satisfy TDAC, the MDCT-based encoding may be performed by overlapping windows between frames. Accordingly, the encoders 4941 and 4943 may perform encoding by adjusting a length of an overlap area of a window based on the transitions transferred from the encoders 4930 and 4920. Thus, a bitstream formatter 4950 may enable the transition not to be included in the bitstream.

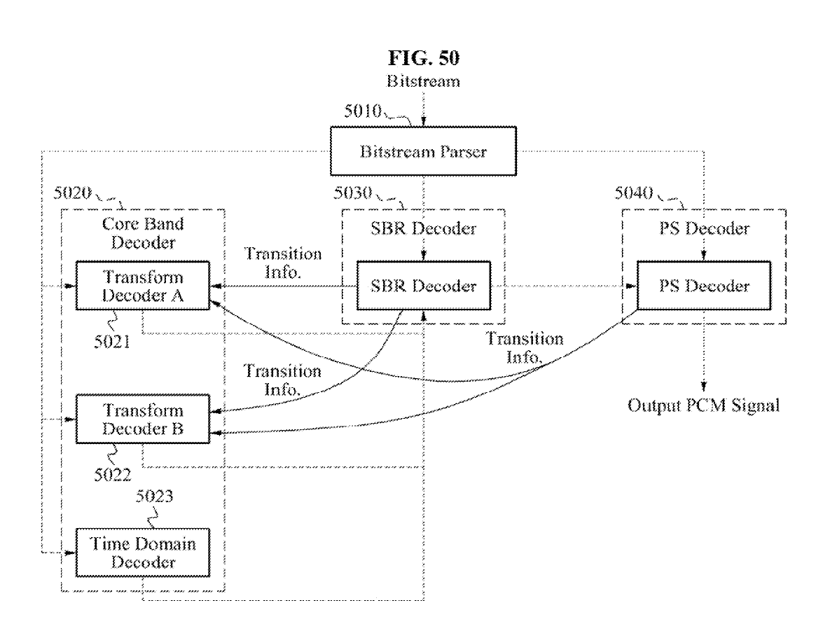

FIG. 50 is a diagram illustrating an actual applicable example of FIG. 48.

FIG. 50 illustrates an actual configuration of a USAC. A bitstream parser 5010 may parse a bitstream transferred from a USAC. A core-decoder 5020 may perform core-decoding using decoders 5021, 5022, and 5023, based on a state of an input signal that is extracted from the parsed bitstream.

Here, the decoder 5021 may correspond to the MDCT-based encoder 4941, and the decoder 5022 may correspond to the frequency domain encoder 4943. Additionally, the decoder 5023 may correspond to the time domain encoder 4944.

The decoder 5021 that performs decoding by overlapping windows based on MDCT, and the decoder 5022 may utilize transitions extracted from results of decoding performed by decoders 5030 and 5040, even when a transition is not included in the bitstream. Subsequently, the decoders 5021 and 5022 may perform decoding by adjusting a length of an overlap area of a window based on the transition. Here, the decoder 5030 may use a Spectral Band Replication (SBR) decoding scheme corresponding to the encoder 4930, and the decoder 5040 may use a PS scheme.

As a result, although a transition is not included in a bitstream, the USAC of FIG. 50 may perform decoding by adjusting a length of an overlap area of a window based on transitions extracted from independently operating decoders of the core-decoder 5020.

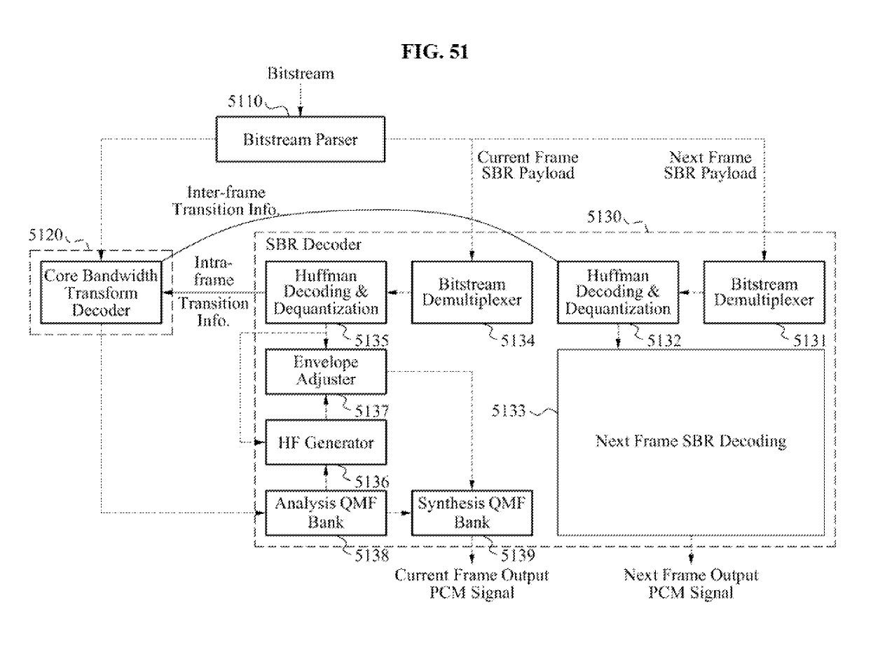

FIG. 51 is a diagram illustrating a process of applying a transition extracted through an SBR decoding scheme to a core band decoding scheme.

Referring to FIG. 51, an SBR decoder 5130 may detect a transition that is generated within a super frame, namely, an intra-frame, using an SBE scheme.

A bitstream parser 5110 may parse a bitstream, and may derive an input signal. Here, an SBR payload of a current frame may be transferred to a decoder 5135 through a bitstream demultiplexer 5134. Here, the decoder 5135 may perform Huffman decoding and dequantization. Subsequently, the current frame may be decoded by the decoder 5135, and a transition generated within the current frame, namely the super frame, may be transferred to a core decoder 5120. Here, the transition may be associated with the intra-frame.

Additionally, an SBR payload of a next frame may be transferred to a decoder 5132 through a bitstream demultiplexer 5131. Here, the decoder 5132 may perform Huffman decoding and dequantization. Subsequently, the next frame may be decoded by the decoder 5132, and a transition generated between the current frame and next frame that are super frames may be transferred to the core decoder 5120. Here, the transition may be associated with the inter-frame, and may be generated in a start portion of the next frame. The next frame decoded by the decoder 5132 may be transferred to a decoder 5133.

The current frame decoded by the decoder 5135 may be derived as a current frame output PCM signal through an envelope adjuster 5137, an HF generator 5136, a QMF bank analyzer 5138, and a QMF bank synthesizer 5139.

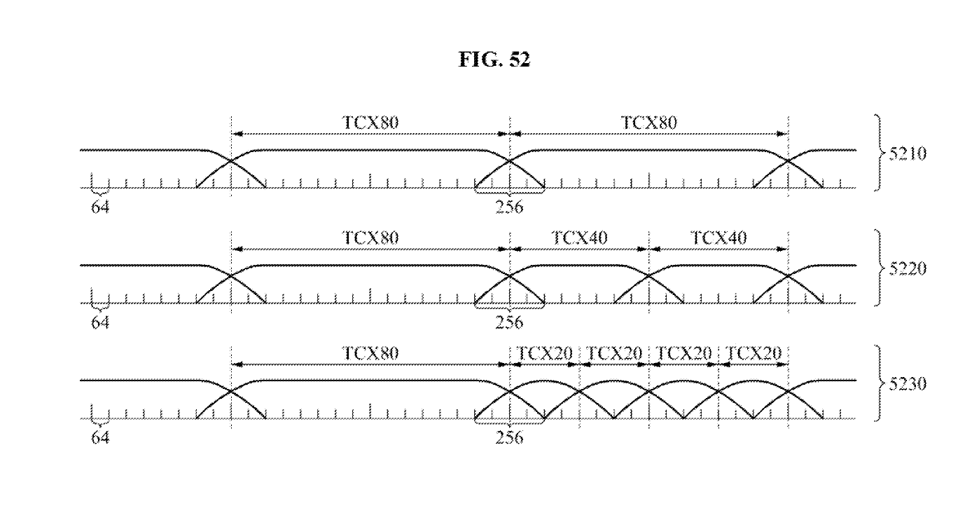

FIG. 52 is a diagram illustrating window sequences where overlap areas of windows have a same length, regardless of an LPD mode.

Referring to FIG. 52, a TCX encoder of a USAC may use a window having an overlap area with a 256 sample length, regardless of the LPD mode. Referring to a window sequence 5210, when a super frame to which a TCX 80 is applied is shown after another super frame to which a TCX 80 is applied, in the LPD mode, a window applied between the super frames may have an overlap area with a 256 sample length. Additionally, referring to a window sequence 5220, when a super frame to which a TCX 40 is applied is shown after a super frame to which a TCX 80 is applied, a window applied between the super frames may have an overlap area with a 256 sample length. Furthermore, referring to a window sequence 5230, when a super frame to which a TCX 20 is applied is shown after a super frame to which a TCX 80 is applied, a window applied between the super frames may have an overlap area with a 256 sample length.

Here, the TCX 80 indicates that a single super frame includes a single sub-frame, the TCX 40 indicates that a single super frame includes two sub-frames, and the TCX 20 indicates that a single super frame includes four sub-frames.

In other words, FIG. 52 illustrates an example where overlap areas of windows have a 256 sample length, regardless of the LPD mode.

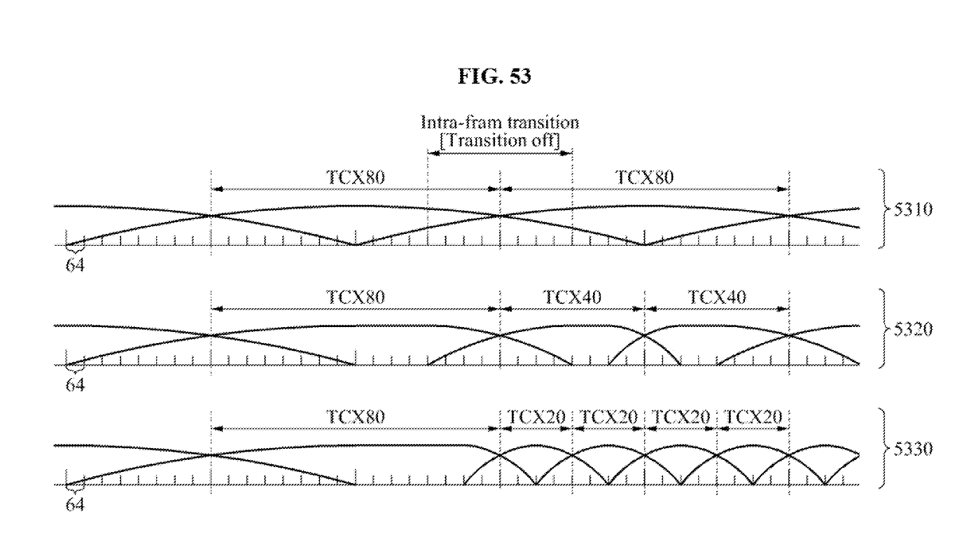

FIG. 53 is a diagram illustrating window sequences where overlap areas of windows have relatively long lengths, in comparison with FIG. 52.

In FIG. 52, the overlap areas of the windows have the 256 sample length regardless of the LPD mode, whereas in FIG. 53, the window sequences of FIG. are configured with windows having relatively long overlap areas in order to increase an encoding efficiency.

Referring to a window sequence 5310, when a super frame to which a TCX 80 is applied is shown after another super frame to which a TCX 80 is applied, in the LPD mode, a window applied between the super frames may have an overlap area with a 1024 sample length. Additionally, referring to a window sequence 5320, when a super frame to which a TCX 40 is applied is shown after a super frame to which a TCX 80 is applied, a window applied between the super frames may have an overlap area with a 512 sample length. Furthermore, referring to a window sequence 5330, when a super frame to which a TCX 20 is applied is shown after a super frame to which a TCX 80 is applied, a window applied between the super frames may have an overlap area with a 256 sample length.

However, a window having a long overlap area may be applied only between super frames. A USAC may measure a Signal to Noise Ratio (SNR) through the closed-loop stage, and may determine a TCX that is an LPD mode. Here, division of a single super frame into several sub-frames, such as the TCX 40 or TCX 20, instead of the TCX 80 where a single super frame includes a single sub-frame, may indicate that a transition generated within the super frame is detected in the closed-loop state. Accordingly, the USAC may divide a single super frame into several sub-frames, thereby preventing propagation of quantization noise such as a pre-echo. In other words, division of a single super frame into several sub-frames may indicate an existence of a transition where a quantization noise occurring within the super frame. Accordingly, overlapping of windows with a 256 sample length that is relatively short sample length, may be more effective than applying of a window having an overlap area with a relatively long sample length.

As a result, embodiments of FIG. 53 may be used only when windows having overlap areas with long sample lengths are overlapped between super frames.

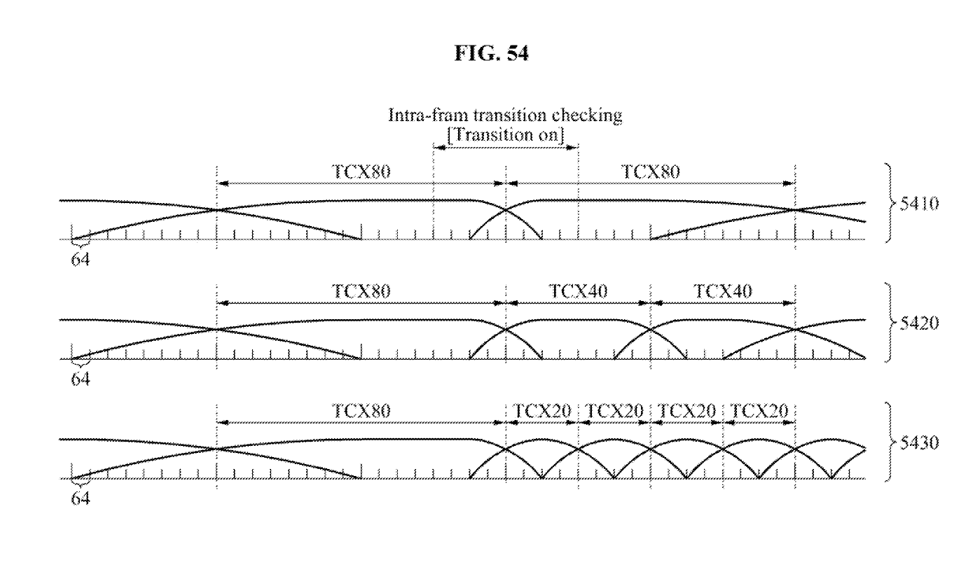

FIG. 54 is a diagram illustrating a result of applying, to a window sequence, a scheme of adjusting a length of an overlap area of a window based on a transition.

As provided in FIG. 53, when a window having an overlap area with a long sample length between super frames is applied, and when there is no transition, a relatively high encoding gain may be obtained. However, when a transition is generated in the overlap area, it is impossible to effectively process a noise such as pre-echo.

To solve such a problem, in the present invention, a length of an overlap area of a window may be adjusted based on a transition. Specifically, as shown in FIG. 54, the USAC may determine whether a transition is generated between super frames. For example, when it is impossible to divide a super frame into sub-frames corresponding to the TCX 40 or TCX 20 in order to effectively process a pre-echo that is a noise caused by a transition even when the transition is generated between super frames of a window sequence 5310, the USAC may adjust a length of an overlap area of a window applied between super frames from a 1024 sample to a 256 sample. Such a processing scheme may be effectively applied to an example where a transition is generated in a location adjacent to a boundary of super frames.

For example, referring to a window sequence 5410, when a super frame to which a TCX 80 is applied is shown after another super frame to which a TCX 80 is applied, in the LPD mode, and when a transition is generated in a boundary of the super frames, a window having an overlap area reduced from a 1024 sample to a 256 sample may be applied between the super frames. Additionally, referring to a window sequence 5420, when a super frame to which a TCX 40 is applied is shown after a super frame to which a TCX 80 is applied, and when a transition is generated in a boundary of the super frames, a window having an overlap area reduced from a 512 sample to a 256 sample may be applied between the super frames. However, referring to a window sequence 5430, when a super frame to which a TCX 20 is applied is shown after a super frame to which a TCX 80 is applied, even when a transition is generated in a boundary of the super frames, a window having an overlap area with a 256 sample length, namely the original sample length, may be applied between the super frames.

In FIG. 54, the length of the overlap area reduced due to generation of the transition may not be limited to the 256 sample, and may be changed depending on a characteristic of a signal.

According to the present invention, a USAC having different kinds of encoding/decoding modes may increase an encoding efficiency using a window sequence that is longer than that of a conventional art, and simultaneously may reduce a length of an overlap window only in a transition based on information of the transition, thereby preventing an efficiency in the transition from being reduced when a long overlap window is used.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A Unified Speech and Audio Codec (USAC), comprising:
a transition detector to detect a first transition from an input signal;
a first encoder to encode the input signal and to detect a second transition from a result of the encoding;
a transition determination unit to compare the first transition and the second transition and to determine a final transition;
a second encoder to core-encode the input signal by adjusting a length of an overlap area of a window based on the determined transition; and
a bitstream formatter to generate a bitstream comprising the core-encoded input signal and the final transition.

2. The USAC of claim 1, wherein the first encoder performs either a Spectral Bandwidth Extension (SBE) encoding scheme or a Parametric Stereo (PS) encoding scheme.

3. The USAC of claim 1, wherein the transition detector detects a transition in a location adjacent to a boundary of a super frame comprising at least one sub-frame among a plurality of sub-frames in the input signal.

4. The USAC of claim 1, wherein the second encoder core-encodes the input signal by applying a window having an overlap area of which a length is reduced by a transition based on a folding point.

5. The USAC of claim 4, wherein the second encoder core-encodes the input signal by applying, to a current sub-frame to be encoded, a window that is transformed based on a Linear Prediction Domain (LPD) mode of a previous sub-frame and an LPD mode of a next sub-frame.

6. A Unified Speech and Audio Codec (USAC), comprising:
a first encoder to encode an input signal and to detect a transition from a result of the encoding;
a second encoder to core-encode the input signal by adjusting a length of an overlap area of a window based on the detected transition; and
a bitstream formatter to generate a bitstream comprising the core-encoded input signal.

7. The USAC of claim 6, wherein the first encoder performs either a Spectral Bandwidth Extension (SBE) encoding scheme or a Parametric Stereo (PS) encoding scheme.

8. The USAC of claim 6, wherein the second encoder core-encodes the input signal by applying a window having an overlap area of which a length is reduced by a transition based on a folding point.

9. The USAC of claim 8, wherein the second encoder core-encodes the input signal by applying, to a current sub-frame to be encoded, a window that is changed based on a Linear Prediction Domain (LPD) mode of a previous sub-frame and an LPD mode of a next sub-frame.

10. A Unified Speech and Audio Codec (USAC), comprising:
a bitstream parser to parse a bitstream and to extract a transition; and
a decoder to core-decode an input signal by adjusting a length of an overlap area of a window based on the transition.

11. The USAC of claim 10, wherein the decoder core-decodes the input signal by applying a window having an overlap area of which a length is reduced by a transition based on a folding point.

12. The USAC of claim 11, wherein the decoder core-decodes the input signal by applying, to a current sub-frame to be decoded, a window that is changed based on a Linear Prediction Domain (LPD) mode of a previous sub-frame and an LPD mode of a next sub-frame.

13. The USAC of claim 11, wherein the transition is either a transition extracted from an input signal, or a transition extracted from a result of encoding an input signal.

14. A Unified Speech and Audio Codec (USAC), comprising:
a bitstream parser to parse an input signal from a bitstream;
a first decoder to decode the input signal and to detect a transition from a result of the decoding; and
a second decoder to core-decode the input signal by adjusting a length of an overlap area of a window based on the detected transition.

15. The USAC of claim 14, wherein the first decoder performs either a Spectral Bandwidth Extension (SBE) decoding scheme or a Parametric Stereo (PS) decoding scheme, and
wherein the second decoder core-decodes the input signal by applying a window having an overlap area of which a length is reduced by a transition based on a folding point.

16. The USAC of claim 15, wherein the second decoder core-decodes the input signal by applying, to a current sub-frame to be decoded, a window that is changed based on a Linear Prediction Domain (LPD) mode of a previous sub-frame and an LPD mode of a next sub-frame.

17. A method performed by a Unified Speech and Audio Codec (USAC), the method comprising:
detecting a first transition from an input signal;
encoding the input signal and detecting a second transition from a result of the encoding;
comparing the first transition and the second transition and determining a final transition;
core-encoding the input signal by adjusting a length of an overlap area of a window based on the determined transition; and
generating a bitstream comprising the core-encoded input signal and the final transition.

18. A method performed by a Unified Speech and Audio Codec (USAC), the method comprising:
encoding an input signal and detecting a transition from a result of the encoding;
core-encoding the input signal by adjusting a length of an overlap area of a window based on the detected transition; and
generating a bitstream comprising the core-encoded input signal.

19. A method performed by a Unified Speech and Audio Codec (USAC), the method comprising:
parsing a bitstream and extracting a transition; and
core-decoding an input signal by adjusting a length of an overlap area of a window based on the transition.

20. A method performed by a Unified Speech and Audio Codec (USAC), the method comprising:
parsing an input signal from a bitstream;
decoding the input signal and detecting a transition from a result of the decoding; and
core-decoding the input signal by adjusting a length of an overlap area of a window based on the detected transition.
